(19) United States
(12) Patent Application Publication
(10) Pub. No.: US 2005/0276199 A1
(43) Pub. Date: Dec. 15, 2005

(54) Optical disk identification device

(76) Inventor: Satoshi Sugai, Ota-ku (JP)

Correspondence Address: MCDERMOTT WILL & EMERY LLP, 600 13TH STREET, N.W., WASHINGTON, DC, 20005-3096, US

(21) Appl. No.: 11/147,395

(22) Filed: Jun. 8, 2005

(30) Foreign Application Priority Data
Jun. 9, 2004 (JP) 2004-171072

(51) Int. Cl. G11B 7/00; G11B 5/09

(52) U.S. Cl. 369/53.22; 369/44.27; 369/53.2; 369/47.1

(57) ABSTRACT

The present invention provides an optical disk identification device for use in an optical disk reproduction apparatus for reproducing a plurality of types of optical disks based on information recorded on the optical disks. Recorded information is reproduced from an optical disk 1 while an optical pickup 3 is fixed at a focal position Pf. A focal position detector 32 generates a focal position detection signal Sg that is either at a high level or at a low level at the focal position Pf based on reproduced signals Sa, Sb, Sc, Sd. An RF signal detector 20 detects an RF signal Srf from the reproduced signal based on the focal position detection signal Sg. A recording density identifier 31, S14, S20 identifies the recording density of the optical disk based on the RF signal. A format identifier S16 to S24 identifies the type of the optical disk based on the detected recording density.

### BACKGROUND OF THE INVENTION

1. Field of the Invention

The present invention relates to an optical disk identification device for use in an optical disk reproduction apparatus for reproducing a plurality of types of optical disks, and more particularly to an optical disk identification device for identifying the type of an optical disk among optical disks having different recording densities, optical disks having different periods of wobbles formed along the tracks, and optical disks having different numbers of recording layers.

2. Description of the Background Art

Various types of optical disks are currently being used, including read-only CD-ROM, writable CD-R and CD-RW, read-only DVD-ROM, and writable DVD such as DVD-R, DVD-RW and DVD-RAM, for example. It is naturally expected that new types of optical disks will be developed in the future.

It is ideal that an optical disk reproduction apparatus can reproduce all of the existing types of optical disks including those mentioned above. However, different types of optical disks have different recording densities or different track pitches, and may even differ in the reproduction method, etc. Therefore, before an optical disk is reproduced, an optical disk reproduction apparatus needs to identify the type of the optical disk.

A conventional method for identifying the type of an optical disk is to utilize the reflectance difference between signals obtained in the focus search operation, as proposed in Japanese Laid-Open Patent Publication Nos. 5-101402 and 11-066712. Japanese Laid-Open Patent Publication No. 2001-332009 proposes another conventional method in which the interval at which sync signals appear is detected. Japanese Laid-Open Patent Publication Nos. 9-198.779 and 2002-312933 propose another conventional method for identifying the type of a recordable disk utilizing the fact that different types of recordable disks have different wobble periods.

With the method that utilizes the reflectance difference between signals obtained in the focus search operation, the type of an optical disk is identified based on the amount of light that is reflected from the optical disk when the optical disk is irradiated with laser light. Therefore, the level with which the type of an optical disk is identified (“identification level”) varies due to variations in the surface condition among optical disks, variations in the quality among individual optical disks, and variations in the laser light intensity, which may cause an erroneous identification.

With the method that identifies the type of an optical disk based on the sync signals of RF signals recorded on the optical disk, it is possible to eliminate the problem of an erroneous identification due to variations in the identification level. However, in order to identify the type of an optical disk based on the sync signal, it is necessary to at least activate the focus servo control. The servo control operation may not become stable, thus failing to identify the type of an optical disk, for some types of optical disks to be identified, due to the substrate thickness and/or reflected light signal intensity being different from those of other types of optical disks.

With the optical disk type identification method that utilizes the wobble period, the identification operation is performed with the servo control being activated, as in the identification method based on the interval at which sync signals appear. Therefore, the identification operation may fail if the servo control does not function stably.

### SUMMARY OF THE INVENTION

Therefore, an object of the present invention is to provide an optical disk identification device capable of reading information of an optical disk and identifying the type of the optical disk without activating the focus servo control.

The present invention provides an optical disk identification device for identifying at least two types of optical disks of different formats from each other, including:
means for spinning an optical disk;
optical pickup means for irradiating a recording surface of the optical disk with laser light and receiving reflected light from the recording surface;
focus drive control means for generating a focus drive value for driving focus actuator means for adjusting a distance between an object lens of the pickup means and the recording surface;
photodetection signal generation means for generating a photodetection signal representing a state of the recording surface based on an intensity of the reflected light;
focus drive value detection means for detecting, based on the photodetection signal, a focus drive value when the object lens is located at a focal position at which the laser light properly converges to form a spot on the recording surface;
focal position fixing means for providing a fixed output of the detected focus drive value to the focus actuator means to fix the object lens at the detected focal position;
focal position detection means for generating, based on the photodetection signal, a focal position detection signal that is either at a high level or at a low level when the object lens is located at the focal position;
RF signal detection means for detecting an RF signal from the photodetection signal based on the focal position detection signal;
recording density identification means for identifying a recording density of the optical disk based on the RF signal; and
format identification means for identifying a format of the optical disk based on the detected recording density.

With the present invention, it is possible to identify at least two types of optical disks of different formats from each other according to the recording density of information recorded on the optical disks without activating the focus servo control. Therefore, the present invention can be used in an optical disk reproduction apparatus for reproducing various types of optical disks.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of an optical disk reproduction apparatus including an optical disk identification device according to an embodiment of the present invention;

FIG. 2 is a waveform diagram showing various signals observed in the optical disk reproduction apparatus of FIG. 1 when an optical pickup is in a focal position;

FIG. 3 is a diagram showing how a first gate signal is generated based on a focus error signal shown in FIG. 2;

FIG. 4 is a diagram showing how a second gate signal is generated based on a total sum signal shown in FIG. 2;

FIG. 5 is a diagram showing a wobble signal shown in FIG. 2;

FIG. 6 is a waveform diagram showing various signals observed in the optical disk reproduction apparatus of FIG. 1 in an optical disk identification operation;

FIG. 7 is a block diagram showing a configuration of a sync signal detector shown in FIG. 1;

FIG. 8 is a waveform diagram showing the relationship between an RF signal, a gate signal, a phase difference off-track signal and an intermittent RF digitized signal when an optical pickup is at a focal position Pf in an optical disk identification device shown in FIG. 6; FIG. 9 is a block diagram showing a configuration of a wobble signal detector shown in FIG. 1;

FIG. 10 is a waveform diagram showing various signals observed in the optical disk identification device shown in FIG. 1 when an optical disk is a double-layer DVD disk;

FIG. 11 is a diagram showing a method for identifying whether an optical disk is a single-layer DVD disk or a double-layer DVD disk in the optical disk identification device shown in FIG. 1;

FIG. 12 is a flow chart showing primary steps of an optical disk identification process performed by the optical disk identification device shown in FIG. 1;

FIG. 13 is a flow chart showing in detail an optical disk abnormality determination subroutine #100, a focus adjustment subroutine #200, a recorded/unrecorded check subroutine #300 and a CD/DVD identification subroutine #400 shown in FIG. 12;

FIG. 14 is a flow chart showing in detail a CD identification subroutine #500 shown in FIG. 12;

FIG. 15 is a flow chart showing in detail a DVD identification subroutine #600 shown in FIG. 12; and

FIG. 16 is a flow chart showing a typical method for identifying an optical disk having a plurality of formats.

### DESCRIPTION OF THE PREFERRED EMBODIMENTS

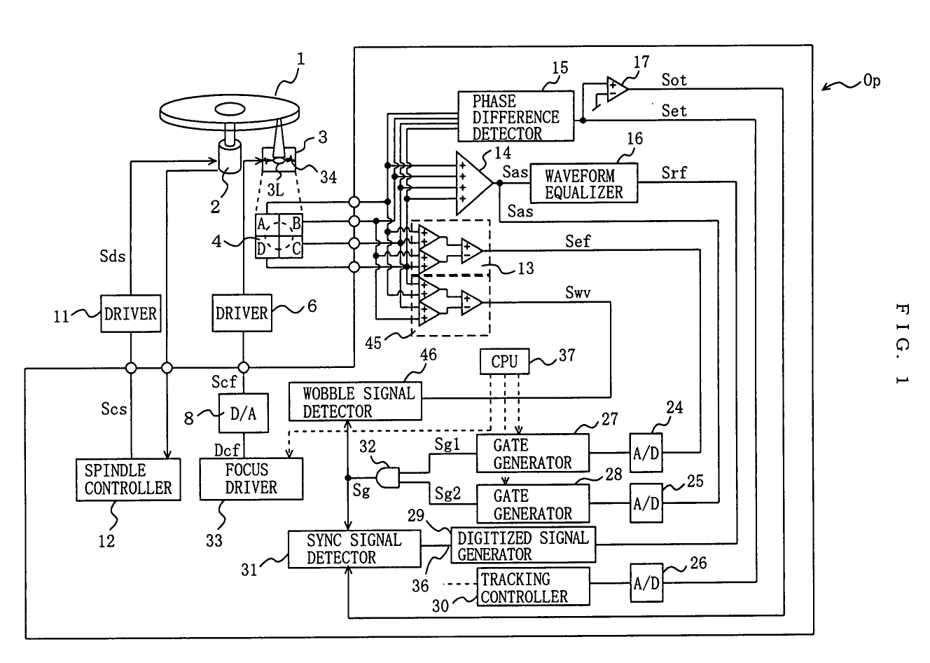

FIG. 1 shows a configuration of an optical disk reproduction apparatus including an optical disk identification device according to an embodiment of the present invention. An optical disk reproduction apparatus Op includes a spindle 2 for spinning an optical disk 1, an optical pickup 3 for irradiating the recording surface of the optical disk 1 with light, a photodetector 4 for receiving light that is reflected from the recording surface of the optical disk 1 to generate an electric signal, a focus actuator 34 for adjusting the focus of the optical pickup 3, a focus actuator driver 6 for driving the focus actuator 34, a spindle motor driver 11 for spinning the spindle 2, and an optical disk controller C for processing information read from the reflected light and controlling the overall operation of the optical disk reproduction apparatus Op.

The optical disk controller C includes a D/A converter 8, a spindle controller 12, a focus error signal generator 13, a total sum signal generator 14, a phase difference detector 15, an off-track signal generator 17, a waveform equalizer 16, a first A/D converter 24, a second A/D converter 25, a third A/D converter 26, a first gate generator 27, a second gate generator 28, a digitized signal generator 29, a tracking controller 30, a sync signal detector 31, a focus driver 33, a wobble signal generator 45, a wobble signal detector 46 and a CPU 100.

The CPU 100 controls the overall operation of the optical disk controller C while controlling the individual elements of the optical disk controller C. Note that the first A/D converter 24, the second A/D converter 25 and the third A/D converter 26 are each denoted simply as “A/D” in the figures due to space limitations. For the same reason, the first gate generator 27 and the second gate generator 28 are each denoted simply as “gate generator”. The focus actuator driver 6 and the spindle motor driver 11 are each denoted simply as “driver”.

The spindle controller 12 generates a spindle control signal Scs for specifying the spin rate of the spindle 2. The spindle motor driver 11 generates a spindle drive signal Sds for spinning the spindle 2 based on the spindle control signal Scs. The spindle 2 is driven based on the spindle drive signal Sds and generates a spin rate signal Ssr representing the spin rate of itself. The spindle controller 12 generates the spindle control signal Scs based on the spin rate signal Ssr so that the spin rate of the spindle 2 is at a predetermined value. Driving control methods of this type include an FG (Frequency Generator) control.

The optical pickup 3 irradiates the recording surface of the optical disk 1 with laser light and drives the focus actuator 34 based on the reflected light to move an object lens 3L in the vertical direction with respect to the recording surface of the optical disk 1 so that a laser spot is properly formed along a track on the recording surface of the optical disk 1. Thus, the focus driver 33 generates a focus drive control data Dcf for moving the object lens 3L to a predetermined position. The D/A converter 8 performs a D/A conversion on the focus drive control data Dcf output from the focus driver 33 to generate a focus drive control signal Scf.

The focus actuator driver 6 generates a focus drive signal Sdf for driving the focus actuator 34 based on the focus drive control signal Scf. Based on the focus drive signal Sdf, the focus actuator 34 moves the optical pickup 3 to a specified position. Thus, based on the focus drive control data Dcf output from the focus driver 33, the distance between the object lens 3L and the recording surface of the optical disk 1 is adjusted, i.e., the position of the focal point at which the laser light forms a normal spot with respect to the recording surface of the optical disk 1. This operation will be referred to as the focus adjustment of the optical pickup 3, and the position of the object lens 3L at which laser light properly forms a spot on the recording surface of the optical disk 1 will be described as the optical pickup 3 being at a focal position Pf. Note that the term “laser spot” as used herein refers to laser light converging at the focal point of the object lens 3L.

In the illustrated example, the optical pickup 3 outputs laser light having a wavelength of 650 nm, which is used for reproducing DVDs. This is because the present invention identifies the type of an optical disk by reading the signal of reflected light from the information recording surface of the optical disk, whereby with CD laser having a long wavelength and a small aperture ratio, the reflected light may not have a sufficient amount of energy for accurately reading a DVD signal. In this sense, the wavelength of laser light output from the optical pickup 3 is of course not limited to 650 nm as long as there is obtained a sufficient amount of energy for reading a signal from reflected light.

The photodetector 4 converts reflected light from the optical disk 1 to an electric signal. The detection region of the photodetector 4 is divided into four regions. The four detection regions are designated herein as detection regions A, B, C and D. The detection regions A, B, C and D output photodetection signals Sa, Sb, Sc and Sd, respectively, according to the intensity of received light.

The total sum signal generator 14 performs an addition operation as shown in Expression 1 below on the photodetection signals Sa, Sb, Sc and Sd output from the photodetection regions of the photodetector 4 to generate a total sum signal Sas. The total sum signal Sas is input to the waveform equalizer 16 and the second A/D converter 25.
Sas=Sa+Sb+Sc+Sd Exp. 1

The waveform equalizer 16 equalizes the waveform of the total sum signal Sas to output the obtained signal to the digitized signal generator 29 as an RF signal Srf being a signal representing information recorded on the optical disk 1. The digitized signal generator 29 digitizes the RF signal Srf to generate an RF digitized signal Sbr. The RF digitized signal Sbr is input to the sync signal detector 31.

The focus error signal generator 13 performs a difference operation as shown in Expression 2 below on the photodetection signals Sa, Sb, Sc and Sd output from detection regions A, B, C and D of the photodetector 4 to generate a focus error signal Sef.
Sef=(Sa+Sc)−(Sb+Sd) Exp. 2

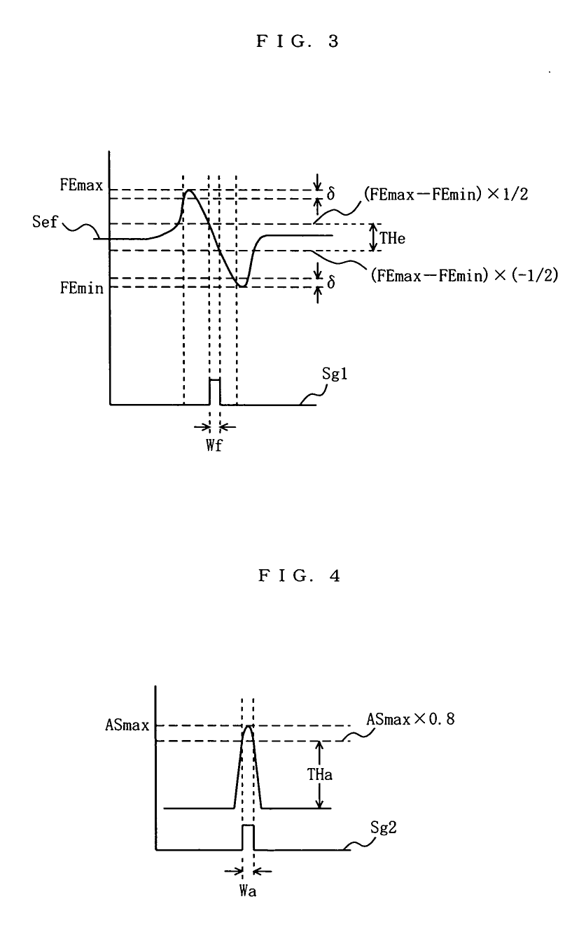

The focus error signal Sef is subjected to an A/D conversion by the first A/D converter 24, and is input to the first gate generator 27. Based on the waveform characteristics of the focus error signal Sef, the first gate generator 27 generates a first gate signal Sg1 that goes high when the optical pickup 3 (the object lens 3L) is located at the focal position Pf. Thus, the first gate signal Sg1 indicates, based on the focus error signal Sef, whether or not the optical pickup 3 is located at the focal position Pf. This will later be described in detail with reference to FIG. 3.

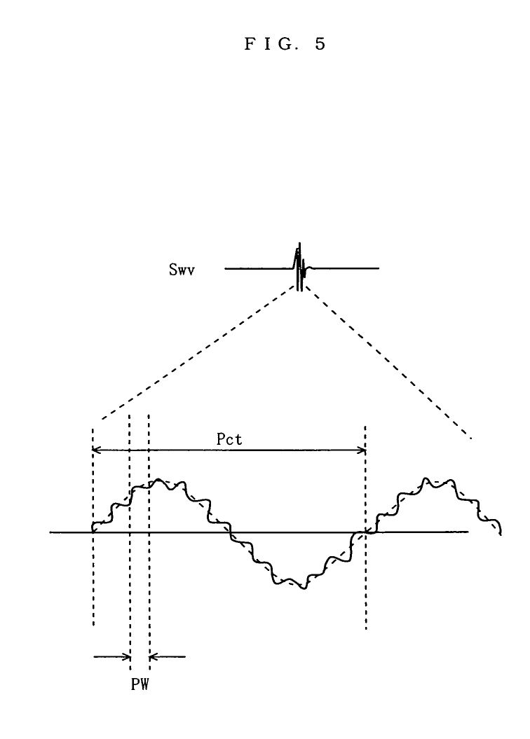

The second A/D converter 25 performs an A/D conversion on the total sum signal Sas from the total sum signal generator 14, and outputs the obtained signal to the second gate generator 28. Based on the waveform characteristics of the total sum signal Sas, the gate signal generator 28 generates a second gate signal Sg2 that goes high when the optical pickup is located at the focal position Pf. Thus, the second gate signal Sg2 indicates, based on the total sum signal Sas, whether or not the optical pickup 3 is located at the focal position Pf. This will later be described in detail with reference to FIG. 4.

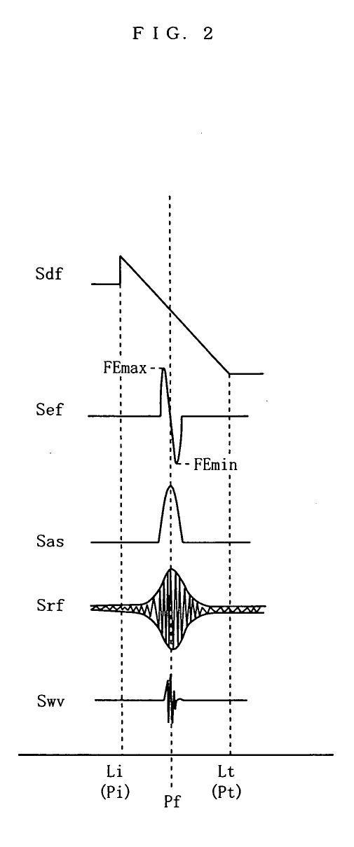

The determination of the focal position Pf and the control of the focus driver 33 based on the focus error signal Sef and the total sum signal Sas according to the present embodiment are done by the CPU 100. This will later be described in detail with reference to FIG. 2, FIG. 3 and FIG. 4.

The phase difference detector 15 performs an arithmetic operation on the photodetection signals Sa, Sb, Sc and Sd from the photodetector 4 to generate a phase difference tracking error signal Set. The tracking error signal is generated by using a differential phase detection (DPD method) of detecting the phase difference in the photodetector outputs. As with the focus error signal Sef and the total sum signal Sas, the phase difference tracking error signal Set is subjected to an A/D conversion by the third A/D converter 26, and is input to the tracking controller 30. The tracking controller 30 controls the tracking position of the optical pickup 3 after the optical disk is identified. Note that the tracking information, but not the tracking error signal Sef, is used as the gate signal for identifying the optical disk in the present embodiment. This will later be described in detail.

The off-track signal generator 17 compares the phase difference tracking error signal Set with a predetermined tracking error level to generate a phase difference off-track signal Sot. The sync signal detector 31 determines whether or not the laser light is located along the track of the optical disk when the optical pickup 3 is at the focal position Pf based on the phase difference off-track signal Sot.

The wobble signal generator 45 performs a difference operation as shown in Expression 9 below on the photodetection signals Sa, Sc, Sb and Sd from detection regions A, B, C and D of the photodetector 4 to generate a wobble signal Swv.
Swv=(Sa+Sd)−(Sb+Sc) Exp. 3

The wobble signal Swv has information reflecting the wobbling of the track groove made on a recordable optical disk for purposes such as to recognize the current position at which data is being recorded and to detect the synchronization of recording timings. The wobble period PW, being the period of the wobbling, and the modulation method of the wobble signal Swv vary depending on the type of the recordable optical disk.

The wobble signal detector 46 is connected to the wobble signal generator 45 and a logical product calculator 32, and receives the wobble signal Swv and a gate signal Sg from the wobble signal generator 45 and the logical product calculator 32, respectively. The wobble signal detector 46 detects information such as the wobble period PW from a switching signal SW based on the wobble signal Swv and the gate signal Sg. This will later be described with reference to FIG. 9. (The wobble signal generator 45 and the wobble signal detector 46 are provided so that more types of recordable optical disks 1 can be identified from one another.)

The optical disk identification of the present embodiment will now be described in detail. When the optical disk 1 is inserted in the optical disk reproduction apparatus Op, the optical pickup 3 is first moved by a thread motor (not shown) to a predetermined position with respect to the recording surface of the optical disk 1. It is preferred that the optical pickup 3 is moved to a position close to the inner periphery of the optical disk 1 because the optical disk 1 may carry data only near the inner periphery thereof depending on the recording capacity of the optical disk 1.

As a control method for moving the optical pickup 3 to the predetermined position, a switch capable of detecting that the optical pickup 3 is located at the innermost position of the disk 1 may be used. With this method, the optical pickup 3 is moved to the predetermined position and then a spindle motor 2 is driven so that the optical disk 1 is spun at a predetermined spin rate. After the spin rate of the optical disk 1 becomes stable, the optical disk 1 is irradiated with laser light from the optical pickup 3 and the actuator 34 is driven to move the object lens 3L of the optical pickup 3 in the vertical direction with respect to the recording surface of the optical disk 1 so that the laser light properly forms a spot on the recording surface of the optical disk 1. As stated above, this operation is referred to as the focus adjustment, and the position of the object lens 3L at which the laser light properly forms a spot on the recording surface of the optical disk 1 is referred to as the focal position Pf of the optical pickup 3.

FIG. 2 shows a distance L between the laser spot and the recording surface of the optical disk 1 during the focus adjustment operation, and the signal waveforms representing the focus drive signal Sdf, the focus error signal Sef, the total sum signal Sas, the RF signal Srf and the wobble signal Swv during the focus adjustment operation. In FIG. 2, Lf denotes the focal distance at which the laser light can properly form a spot on the recording surface of the optical disk 1, and the distance is referred to as a focal distance Lf. L<Lf holds true on the left-hand side of the focal distance Lf, and Lf<L holds true on the right-hand side. Thus, in the illustrated example, the focus adjustment operation is performed while the laser spot is moved from a position closer to the optical disk 1 than the focal distance Lf away from the optical disk 1.

Note that in view of the tolerance in the shape of the optical disk 1 and that in the attitude of the optical disk 1 on the spindle 2, the focal distance Lf is allowed to be located within the range between a focus adjustment initiation distance Li and a focus adjustment termination distance Lt as shown in FIG. 2. Therefore, the focus drive signal Sdf takes its maximum value at the focus adjustment initiation distance Li, and the value thereafter gradually decreases to reach its minimum value at the focus adjustment termination distance Lt. Note that the focus actuator 34 acts to locate the optical pickup 3 at the distance L according to the value of the focus drive signal Sdf. Thus, it is the value of the focus drive signal Sdf that dictates the distance L, but not vice versa. Nevertheless, the description herein will use the distance L as the reference, for the sake of simplicity.

Note that since the positional precision of the optical pickup 3 in the optical disk reproduction apparatus Op is ensured, the gap distance L between the recording surface of the optical disk 1 and the optical pickup 3 can be regarded as being the position of the object lens 3L (focused laser spot) in the optical disk reproduction apparatus Op. In view of this, the distance L, the focus adjustment initiation distance Li, the focal distance Lf and the focus adjustment termination distance Lt will be referred to alternatively as an irradiation position P of the optical pickup 3 (the object lens 3L), a focus adjustment initiation position Pi, the focal position Pf and a focus adjustment termination position Pt, respectively.

At the focus adjustment initiation distance Li, the value of the focus error signal Sef is zero. The focus error signal Sef stays zero even if the object lens 3L is moved by the focus actuator 34 in such a manner that the laser spot moves away from the recording surface of the optical disk 1. As the laser spot comes close to the focal distance Lf, the focus error signal Sef increases rapidly. As the laser spot comes closer to the focal distance Lf, the focus error signal Sef then decreases rapidly to reach zero at the focal distance Lf.

As the laser spot comes closer to the optical disk 1 beyond the focal distance Lf, the focus error signal Sef further decreases and then rapidly increases toward zero. Thereafter, the value of the focus error signal Sef stays zero (zero focus adjustment) as the laser spot moves to the focus adjustment termination distance Lt. Thus, the focus error signal Sef transitions in an S-shaped waveform pattern about the focal distance Lf being the center (this will hereinafter be referred to as the “S-shaped characteristics” or “S-shaped waveform”) The maximum value and the minimum value of the S-shaped waveform are designated herein as “FEmax” and “FEmin”, respectively.

As described above, FIG. 2 represents how the reflected light from the optical disk 1 changes as the object lens 3L is moved (or as the laser spot is varied) toward the focal position Pf (the focal distance Lf) with respect to the recording surface of the optical disk 1. The S-shaped characteristics of the focus error signal Sef vary depending on the polarity of the difference calculator 13 of the photodetector 4 and the characteristics of the pickup. For example, if an operation as shown in Expression 4 below is performed by the difference calculator 13, instead of the operation as shown in Expression 2 above, the S-shaped characteristics of the focus error signal Sef will be of an opposite polarity.
Sef=(Sb+Sd)−(Sa+Sc) Exp. 4

As with the focus error signal Sef, the total sum signal Sas varies as the object lens 3L is moved (or as the laser spot is varied). Thus, the total sum signal Sas has an upwardly-protruding waveform in which it starts increasing before the focus error signal Sef starts exhibiting the S-shaped waveform, reaches its maximum value at the focal position Pf, and reaches zero after the focus error signal Sef returns to zero. The maximum value, being the peak of the upwardly-protruding waveform, is designated herein as ASmax.

The RF signal Srf also transitions, as the object lens 3L is moved (or as the laser spot is varied), in an RF waveform corresponding to the information components contained in the reflected light from the optical disk 1 that is received at the irradiation position P (the distance L). Thus, the RF signal Srf reaches its maximum intensity at the focal position Pf (the focal distance Lf).

<Focus Adjustment>

Next, how the focus drive signal Sdf (the focus drive control data Dcf) is generated in the focus adjustment operation will be described. In the present invention, the focus drive signal Sdf is generated based on the focus error signal Sef. Thus, the focus drive signal Sdf (the focus drive control data Dcf) is generated so as to cancel out the difference between the current irradiation position P of the optical pickup 3 and the focal position Pf based on the value of the focus error signal Sef at the irradiation position P of the optical pickup 3 as determined by the operation of the focus actuator 34.

Specifically, the focus driver 33 detects the focus drive control data Dcf corresponding to the irradiation position P at which the focus error signal Sef is zero in the S-shaped characteristics (the zero-crossing point). The zero-crossing point corresponds to the focal position Pf described above, and can be denoted as the irradiation position P(0).

The focus driver 33 further detects the drive value at the irradiation position P (ASmax) at which the total sum signal Sas takes its maximum value ASmax in the upwardly-protruding characteristics, and generates the focus drive control data Dcf. Then, the focus driver 33 outputs the generated focus drive control data Dcf to the focus actuator 34 as the focus drive signal Sdf via the D/A converter 8 and the focus actuator driver 6.

As described above, while the optical pickup 3 is moved from the focus adjustment initiation position Pi to the focus adjustment termination position Pt (preferably from Pi to Pt and back to pi), a focus threshold value THe and a total sum threshold value THa for generating the first gate signal Sg1 and the second gate signal Sg2, and the focus drive control data Dcf for setting the focus driver 33 to the focal position Pf are determined.

<Determining Whether Optical Pickup 3 is at Focal Position Pf>

Referring now to FIG. 3 and FIG. 4, the method of the present invention for determining whether or not the optical pickup 3 is located at the focal position Pf will be described. Note that in the present invention, whether or not the optical pickup 3 is located at the focal position Pf is determined based on both the focus error signal Sef and the total sum signal Sas.

Referring to FIG. 3, the generation of the first gate signal Sg1 indicating the result of determination of whether or not the optical pickup 3 is located at the focal position Pf based on the focus error signal Sef will be described. FIG. 3 shows in detail the S-shaped waveform of the focus error signal Sef, and shows the pulse waveform of the first gate signal Sg1 for the focus error signal Sef. As described above, in the present invention, the level of the first gate signal Sg1 is determined based on the value of the focus error signal Sef. Thus, the focus error signal Sef is used as a trigger for setting the first gate signal Sg1 to a high level when the condition of the focus threshold value THe is satisfied.

The focus threshold value THe is set so that Expressions 5 and 6 below are both satisfied.
THe□(FEmax−FEmin)×0.1/2 Exp. 5
THe□(FEmax−FEmin)×−0.1/2 Exp. 6
Thus, when the value of the focus error signal Sef is in the range of the focus threshold value THe, it is determined that the optical pickup 3 is located at the focal position Pf, and the CPU 100 instructs the first gate generator 27 to output the first gate signal Sg1 at a high level.

Where positions at which the value of the focus error signal Sef is (FEmax−FEmin)×+0.1/2 are denoted as P((FEmax−FEmin)×0.1/2) and P((FEmax−FEmin)×−0.1/2), the focal position Pf in the present invention is recognized as having a width Wf expressed as shown in Expression 7 below.
Wf=P((FEmax−FEmin)×0.1/2)−P((FEmax−FEmin)×−0.1/2) Exp. 7

For the sake of simplicity, the irradiation position P((FEmax−FEmin)×0.1/2) and the irradiation position P((FEmax−FEmin)×−0.1/2) will be referred to simply as an irradiation position Ple and an irradiation position P2e, respectively. In FIG. 3, these positions are denoted as P1e and P2e due to space limitations. Thus, the width Wf can be expressed as shown in Expression 8 below, instead of Expression 7.
Wf=P1e−P2e Exp. 8

As described above, the focal position Pf in the present invention is not a single point but has an acceptable width Wf. This is to take into consideration the fact that since the optical disk reproduction apparatus Op and the optical disk 1 each have a tolerance, the focal position Pf accordingly varies within an acceptable range. Therefore, a smaller width Wf is preferred as it indicates that there is a smaller difference between the focal position Pf and the true focal position.

Note that it is clear from FIG. 3 that the focus error signal Sef may be within the range of the focus threshold value THe even when the optical pickup 3 is outside the width Wf (P<Ple or P>P2e), i.e., even when the optical pickup 3 is completely outside the acceptable range of the focal position Pf from the irradiation position P1e to the irradiation position P2e. Therefore, in the present invention, when moving the optical pickup 3 in the focus adjustment operation, the first gate generator 27 is turned ON when it is detected that the focus error signal Sef is equal to a value obtained by subtracting a predetermined value δ from FEmax (FEmax−δ) and the gate generator is turned OFF when it is detected that the focus error signal Sef is equal to a value obtained by adding the value δ to FEmin (FEmin+δ).

The first gate signal Sg1 is set to a high level only when the first gate generator 27 is ON during the period in which the focus error signal Sef satisfies the focus threshold value THe. The predetermined value δ is an amount of correction that is appropriately determined based on the characteristics and the quality of the optical disk reproduction apparatus Op and the optical disk 1.

Thus, it is ensured that the first gate signal Sg1 does not go high when the optical pickup 3 is at a position outside the acceptable range of the focal position Pf from the irradiation position P1e to the irradiation position P2e. In other words, when the optical pickup 3 is between the irradiation position P1e and the irradiation position P2e, it is tentatively determined that the optical pickup 3 is located at the focal position Pf and thus the first gate signal Sg1 is at a high level.

Since the settings are determined so that the focal position Pf, which varies while the optical disk 1 is spinning, falls within the width Wf, it is tentatively determined that the optical pickup 3 is at the focal position Pf on the assumption that there is an acceptable level of error, as long as the focus error signal Sef satisfies the condition of the focus threshold value THe and that of the predetermined value δ. In this sense, the first gate signal Sg1 is provided as first tentative determination means for the focal position Pf.

Referring now to FIG. 4, the generation of the second gate signal Sg2 indicating the result of determination of whether or not the optical pickup 3 is located at the focal position Pf based on the total sum signal Sas will be described. FIG. 4 shows in detail the upwardly-protruding waveform of the total sum signal Sas, and shows the pulse waveform of the second gate signal Sg2 for the total sum signal Sas. In the present invention, the level of the second gate signal Sg2 is determined based on the value of the total sum signal Sas. Thus, the total sum signal Sas is used as a trigger for setting the second gate signal Sg2 to a high level when the condition of the total sum threshold value THa is satisfied.

The total sum threshold value THa is set so that Expression 9 below is satisfied.
ASmax×0.8□THa□ASmax Exp. 9
Thus, when the value of the total sum signal Sas satisfies the condition of the total sum threshold value THa, it is tentatively determined that the optical pickup 3 is located at the focal position Pf, and the second gate generator 28 is instructed to output the second gate signal Sg2 at a high level.

Where two irradiation positions P at which the value of the total sum signal Sas is Asmax×0.8 are denoted as P1 (Asmax×0.8) and P2 (Asmax×0.8), the focal position Pf in the present invention is recognized as having a width Wa expressed as shown in Expression 10 below.
Wa=P1(Asmax×0.8)−P2(Asmax×0.8) Exp. 10

For the sake of simplicity, the irradiation positions P1(Asmax×0.8) and P2(Asmax×0.8) will be referred to simply as irradiation positions P1a and P2a, respectively. In FIG. 4, these positions are denoted as P1a and P2a due to space limitations. Thus, the width Wa can be expressed as shown in Expression 11 below, instead of Expression 10.
Wa=P1e−P2e Exp. 11

Since the settings are determined so that the focal position Pf, which varies while the optical disk 1 is spinning, falls within the width Wa, it is tentatively determined that the optical pickup 3 is at the focal position Pf on the assumption that there is an acceptable level of error, as long as the total sum signal Sas satisfies the condition of the total sum threshold value THa. In this sense, the second gate signal Sg2 is provided as second tentative determination means for the focal position Pf.

The logical product calculator 32 calculates the logical product of the first gate signal Sg1 and the second gate signal Sg2 generated as described above to generate the gate signal Sg. Therefore, the gate signal Sg is set to a high level when the first gate signal Sg1 and the second gate signal Sg2 are both at a high level. Thus, the product of the first gate signal Sg1 and the second gate signal Sg2 is used, thereby reducing the error in the determination of the focal position Pf due to an acceptable level of error in each of the first gate signal Sg1 and the second gate signal Sg2.

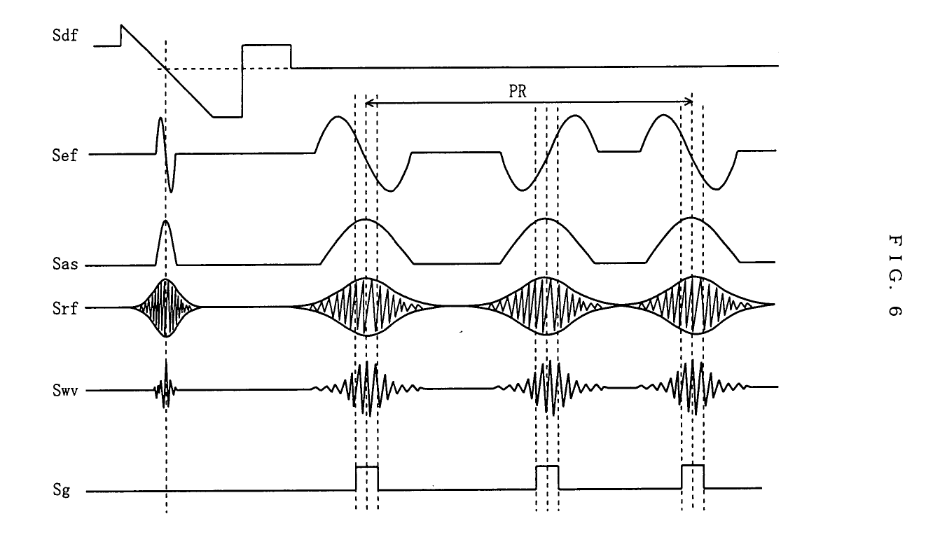

FIG. 5 shows an enlarged waveform of the wobble signal Swv. The wobble signal Swv appears as a signal obtained by combining together a waveform obtained as the laser light moves across the track of the optical disk 1 at the focal position Pf and another waveform that reflects the wobbling of the track. As shown in FIG. 5, each winding in the waveform of the wobble signal Swv corresponds to the wobble period PW, and the period from one zero-level point to another is a track crossing period Pct.

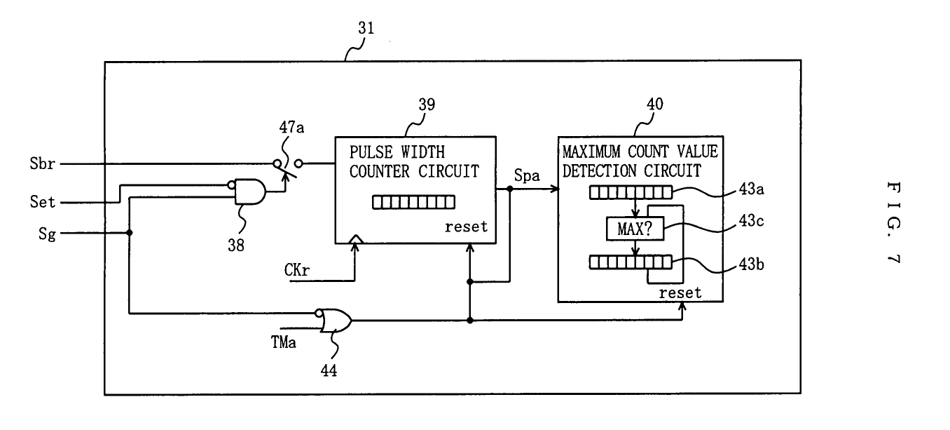

Referring now to FIG. 6, the figure shows transitions over time of the focus drive signal Sdf, the focus error signal Sef, the total sum signal Sas, the RF signal Srf, the wobble signal Swv and the gate signal Sg when the optical pickup 3 is fixed at the focal position Pf by the focus drive control data Dcf (the focus drive signal Sdf) as described above. In FIG. 6, a period t1-t2 is the period of time required for the focus adjustment operation as described above, i.e., a focus adjustment period PRf. A period t3-t4 is the period of time required for identifying the optical disk 1, i.e., an optical disk identification period PRd.

As described above, the focus drive control data Dcf (the focus drive signal Sdf) for the focal position Pf is obtained in the focus adjustment period PRf. Then, at time t3, an fixed output of the obtained focus drive control data Dcf (the focus drive signal Sdf) to the focus actuator 34 is initiated. Thus, the optical pickup 3 outputs laser light while being substantially fixed at the focal position Pf based on the fixed output of the focus drive control data Dcf, without being subject to a servo control. The focus error signal Sef, the total sum signal Sas, the RF signal Srf and the wobble signal Swv, which are generated based on the reflected light from the recording surface of the optical disk 1, exhibit periodical characteristics as shown in the figure. The period substantially coincides with a surface flatness variation period PR of the optical disk 1.

Next, how an optical disk is identified in the optical disk identification period PRd will be described. The identification of an optical disk in the present invention is generally divided into the identification of the type of an optical disk based on the recording density, and the identification of the type of a recordable optical disk based on the wobble signal. Therefore, the identification of the type of an optical disk based on the recording density will first be described, after which the identification of the type of a recordable optical disk based on the wobble signal will be described.

<Identification of Optical Disk Based on Recording Density>

The identification of the type of an optical disk based on the recording density according to the present invention will now be described, with respect to DVDs and CDs. In the present embodiment, an optical disk is identified to be a DVD or a CD by detecting the recording density of the optical disk based on the RF signal Srf at the focal position Pf. DVDs and CDs have different recording densities. For example, a DVD having only one layer of recording surface (hereinafter referred to as a “single-layer DVD disk”) has a shortest pattern length of 0.267 μm and a longest pattern length of 1.866 μm. A DVD having two recording layers (hereinafter referred to as a “double-layer DVD disk”) has a shortest pattern length of 0.293 μm and a longest pattern length of 2.054 μm. While these pattern lengths slightly differ from one CD type to another depending on the linear velocity, a CD whose linear velocity is 1.25 m/s has a shortest pattern length of 0.87 μm and a longest pattern length of 3.18 μm.

Thus, different types of optical disks have different shortest pattern lengths and different longest pattern lengths, i.e., different recording densities. While it is possible to identify the type of an optical disk based on either the shortest pattern length or the longest pattern length, the type of an optical disk is identified based on the longest pattern length in the present embodiment.

In a single-layer DVD disk, a 14T signal, which is the longest pattern signal, appears in a fixed pattern of 14T+4T. If the single-layer DVD disk is spun at 3.49 m/s, which is the standard linear velocity for DVDs, the frequency of the pattern signal is 937 kHz.

A 11T signal, which is the longest pattern signal of a CD, also appears in a fixed pattern of 11T+11T as the sync detection signal. Therefore, if the CD is spun at 3.49 m/s, which is the standard linear velocity for DVDs, as is the single-layer DVD disk, the pattern frequency will be 549 kHz.

If these patterns having such frequencies are counted by a fixed clock of 33 MHz, for example, the count will be about 35 for a single-layer DVD disk and about 60 for a CD. Therefore, by counting the longest pattern signals reproduced from the optical disk 1 by using a pulse width counter, it is possible to identify the type of the optical disk based on the obtained count value. In the present embodiment, the sync signal detector 31 identifies an optical disk to be either a CD or a DVD based on the longest pattern length.

Next, means for identifying the recording density of the optical disk 1 from the frequency of the RF signals Srf, which are taken in at the timing of the gate signal Sg generated as a high-level signal at the focal position Pf.

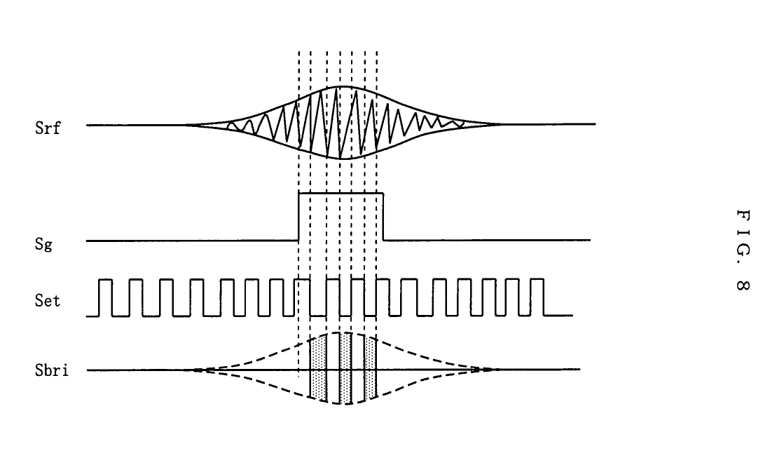

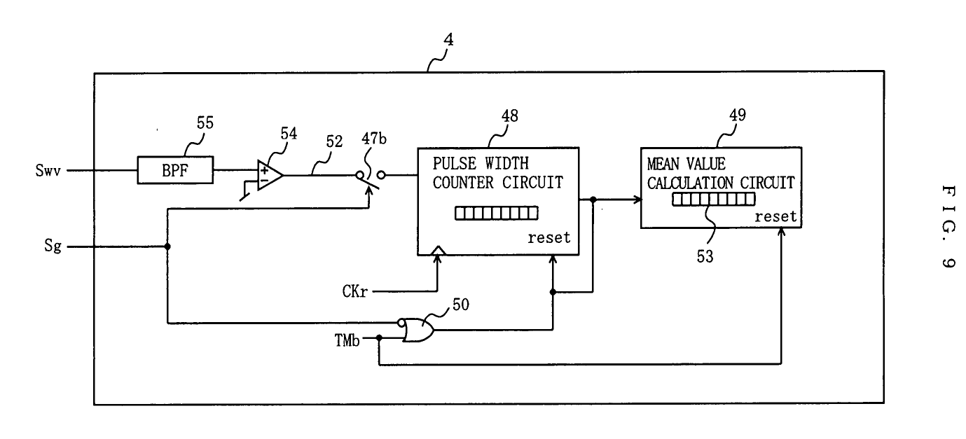

Referring now to FIG. 7 and FIG. 8, the optical disk identification by the sync signal detector 31 will be described. As shown in FIG. 7, the sync signal detector 31 includes a logical product calculator 38, a pulse width counter 39, a maximum count value detector 40, a timer TMa and a switch 47a. The switch 47a is inserted between the digitized signal generator 29 and the pulse width counter 39.

The logical product calculator 38 has an inverted port connected to the off-track signal generator 17 for receiving the phase difference off-track signal Sot, and another port connected to the logical product calculator 32 for receiving the gate signal Sg. The logical product calculator 38 calculates the logical product of the phase difference off-track signal Sot and the gate signal Sg to generate and output the switching signal SW to the switch 47a.

The switch 47a is normally OFF and turned ON in response to the switching signal SW so that the input RF digitized signal Sbr is intermittently output to the pulse width counter 39. The RF digitized signal Sbr, which is output intermittently, will be referred to as an intermittent RF digitized signal Sbri.

A logical sum calculator 44 has an inverted port connected to the logical product calculator 32 for receiving the gate signal Sg, and another port for receiving the timer TMa. The logical sum calculator 44 calculates the logical sum of the inverted gate signal Sg and the timer TMa to generate a reset signal Sr. Note that the reset signal Sr is at a high level when one of the inverted gate signal Sg and the timer TMa is at a high level. The period of the timer TMa is set to be equal to or longer than the period with which the DVD and CD longest pattern signals appear.

The pulse width counter 39 is connected to the logical sum calculator 44 and the switch 47a, and receives the intermittent RF digitized signal Sbri and the reset signal Sr. The pulse width counter 39 also receives an external reference clock CKr. The pulse width counter 39 counts the pulse widths of the intermittent RF digitized signals Sbri when the inverted phase difference off-track signal Sot and the gate signal Sg are both at a high level. Thus, the pulse width counter 39 counts up with the reference clock CKr from when a rising edge of the RF digitized signal Sbr is detected until the next rising edge is detected, thereby generating a count signal Spa. Note that the pulse width counter 39 is reset by the reset signal Sr.

The maximum count value detector 40 is connected to the pulse width counter 39 and the logical sum calculator 44, and receives the count signal Spa and the reset signal Sr. The maximum count value detector 40 includes a first register 43a, a second register 43band a count value comparator 43c. Each time the reset signal Sr is input to the maximum count value detector 40, the first register 43a temporarily stores a pulse width count value CA1 represented by the count signal Spa at that point in time. The second register 43b stores a maximum pulse width count value CA2 among those represented by the count signals Spa that have been input to the maximum count value detector 40.

Each time the value stored in the first register 43a is updated by the count signal Spa, the count value comparator 43c compares the pulse width count value CA1 temporarily stored in the first register 43a with the pulse width count value CA2 stored in the second register 43b so that one of the pulse width count values that is larger is stored in the second register 43b. Note that the maximum count value detector 40 is reset by the reset signal Sr output from the logical sum calculator 44. The pulse width count value CA2 stored in the second register 43b at this point in time is obtained as a maximum pulse width count value CAmax.

FIG. 8 shows the waveforms of the RF signal Srf, the gate signal Sg, the phase difference off-track signal Sot and the intermittent RF digitized signal Sbri in the sync signal detector 31. As can be seen from FIG. 8, the RF digitized signal Sbr input to the sync signal detector 31 is switched by the switching signal SW, which is the logical product of the inverted signal of the phase difference off-track signal Sot and the gate signal Sg, and RF digitized signal Sbr is taken in by the pulse width counter 39 as the intermittent RF digitized signal Sbri only when the optical pickup 3 is located at the focal position Pf (the gate signal Sg being at a high level) and at a tracking position (the phase difference off-track signal Sot being at a low level).

The pulse width count value CA2 of the longest pattern signal (stored in the second register 43b) detected by the sync signal detector 31 is subjected to an integration operation for a specified period of time and is used for the disk type identification through comparison with an expected value. While these operations are performed by means of software in the present invention, they may alternatively be performed by means of hardware.

The identification of an optical disk based on the count signal Spa (the pulse width count value C) will now be described in detail. As shown in FIG. 7 and FIG. 8, the intermittent RF digitized signal Sbri taken in by the pulse width counter 39 is supposed to be the RF digitized signal Sbr when the optical pickup 3 is at the focal position Pf and at an on-track position. However, depending on the type of the optical disk, it is possible that the phase difference off-track signal Sot is not accurately generated. In the worse case, the RF digitized signal Sbr of the RF signal Srf when the optical pickup 3 is at an off-track position may be taken in.

In order to accurately identify the type of an optical disk based on the pulse width counter value C (the count signal Spa), distribution data of the obtained maximum pulse width count values CAmax is obtained and compared with a counter value expected for a DVD or a CD. Specifically, assuming that the frequency of the reference clock CKr used in the pulse width counter 39 is 33 MHz, a count value of about 35 for a DVD or about 60 for a CD is supposedly obtained as the maximum pulse width count value CAmax of the sync signal detector 31.

In view of this, first, unlikely values, e.g., overflowing maximum pulse width count values CAmax (Cmax>35 or 60), are excluded, and the remaining count values C are integrated for a specified period of time so as to identify the optical disk 1 to be either a CD or a DVD based on whether or not the obtained mean value is close to the expected value for a DVD (60) or that for a CD (35). While an example of a method for identifying single-layer DVD disks and CDs from each other has been described above, it is understood that other types of optical disks can be identified from one another in a similar manner as long as they have different recording densities.

<Identification of Recordable Optical Disk Based on Wobble Signal>

The identification of the type of a recordable optical disk will now be described, with respect to DVDs and CDs. While an optical disk can be identified to be a CD or a DVD based on the recording density as described above, CD and DVD are further classified into recordable disks and non-recordable disks, and there are different types of recordable disks. For example, non-recordable optical disks include CD-ROM and DVD-ROM (single-layer DVD disk and double-layer DVD disk).

Recordable optical disks that are already in practical use include CD-R, CD-RW, DVD-RAM, DVD-R, DVD-RW, DVD+R and DVD+RW. Therefore, with the identification process described above, while the optical disk 1 being a non-recordable disk, i.e., a CD-ROM or a single-layer DVD disk, can be reproduced, the optical disk 1 being one of the recordable optical disks as listed above needs to be subjected to a detailed identification process.

In view of this, the present invention performs a further identification of an optical disk based on the period PW of wobbles provided on these recordable optical disks. Simply stated, the method is to take in the wobble signals Swv at the timing of the gate signal Sg generated at the focal position Pf to detect the wobble period PW of the recordable optical disk based on the frequency of the wobble signal Swv so as to identify the type of the recordable optical disk based on the wobble period PW.

Specifically, wobbles of the track groove are made on a recordable optical disk for purposes such as to recognize the current position at which data is being recorded and to detect the synchronization of recording timings. The wobble period PW and the modulation method vary depending on the type of the recordable optical disk (CD), as described above. Specifically, a CD-R or a CD-RW has wobbles formed so that the center frequency will be 22.05 kHz when the optical disk is spun at a standard rate (a linear velocity of 1.2-1.4 m/s). In the present embodiment, the spin rate of the spindle is controlled to be a linear velocity of 3.49 m/s (the standard rate for a single-layer DVD disk). With a linear velocity of 3.49 m/s, the center frequency of the wobble signal of a CD-R or a CD-RW will be about 59.2 kHz.

There are DVD-RAM standards, one with a recording capacity of 2.6 GB (hereinafter referred to as a “2.6-GB DVD-RAM”) and another with a recording capacity of 4.7 GB (hereinafter referred to as a “4.7-GB DVD-RAM”). The particulars of these standards can be found in “DVD Specification for Rewritable Disc (DVD-RAM) Part1: PHYSICAL SPECIFICATIONS Version 1.0” and “DVD Specification for Rewritable Disc (DVD-RAM) Part1: PHYSICAL SPECIFICATIONS Version 2.0”.

The 2.6-GB DVD-RAM and the 4.7-GB DVD-RAM both have a ZCLV format. Wobbles on a DVD-RAM disk are formed so that one wobble period corresponds to 186 channel bits.

In a 2.6-GB DVD-RAM disk, the channel bit length is 0.205-0.218 μm and the linear velocity is 5.96-6.35 m/s in the rewritable region. Therefore, the wobble period PW of 2.6-GB DVD-RAM is about 1/157000, and a wobble frequency FW is about 157 kHz.

In a 4.7-GB DVD-RAM disk, the channel bit length is 0.14-0.146 μm and the linear velocity is 8.16-8.49 m/s in the rewritable region. Therefore, the wobble period PW of 4.7-GB DVD-RAM is about 1/313000, and the wobble frequency FW is about 313 kHz.

In the present embodiment, the spin rate of the spindle 2 is controlled to be a linear velocity of 3.49 m/s (the standard rate for a single-layer DVD disk). With a similar conversion to that for CD-R(RW), the wobble center frequency Fwc is about 92 kHz for 2.6-GB DVD-RAM and about 134 kHz for 4.7-GB DVD-RAM.

For DVD-R and DVD-RW, the wobble period is defined to be eight periods per one sync frame. The particulars of this can be found in, for example, “DVD Specification for Recordable Disc for General (DVD-R for General) Part1: PHYSICAL SPECIFICATIONS Version 2.0”. Since one sync frame includes 1488 channel bits and the channel bit length is 0.133 μm, the wobble period PW for a linear velocity of 3.49 m/s is about 1/141000 and the wobble frequency FW is about 1141 kHz.

For DVD+R and DVD+RW, the wobble period is defined to be 93 periods per two sync frame. The particulars of this can be found in, for example, “Standard ECMA-337 Data Interchange on 120 mm and 80 mm—Optical Disk using +RW Format—Capacity: 4.7 and 1.46 Gbytes per Side” of “ECMA International Standardizing Information and Communication System”. Since one sync frame includes 1488 channel bits and the channel bit length is 0.133 μm, the wobble period PW for a linear velocity of 3.49 m/s is about 1/840000 and the wobble frequency FW is about 840 kHz.

As described above, different types of recordable optical disks have different wobble periods PW and wobble frequencies FW for the same spin rate (linear velocity), and the count of this at a fixed clock of 33 MHz, for example, will be about 557 for CD-R and CD-RW, about 359 for 2.6-GB DVD-RAM, about 246 for 4.7-GB DVD-RAM, about 234 for DVD-R and DVD-RW, and about 39 for DVD+R and DVD+RW. Therefore, by counting the number of digitized wobble signals Swv using a pulse width counter, it is possible to identify different types of recordable optical disks from one another based on the counter value.

Referring to FIG. 9, the optical disk identification using the wobble signal detector 46 will be described. The wobble signal detector 46 includes a switch 47b, a pulse width counter 48, a mean value calculator 49, a logical sum calculator 50, a wobble signal digitizer 54 and a bandpass filter (BPF) 55. The switch 47a is connected to the logical product calculator 32 for receiving the gate signal Sg. The bandpass filter 55 is connected to the wobble signal generator 45 for receiving the switching signal SW.

The wobble signal Swv input to the wobble signal detector 46 passes through the bandpass filter 55, where the band of tracking error signal components and the band of high frequency signal components are removed, after which it is digitized into a wobble digitized signal Sbw through a wobble digitizer 54 for digitizing an input signal at a fixed level. The wobble digitized signal Sbw is switched by the gate signal Sg, and is taken in by the pulse width counter 48 only when the optical pickup 3 is located at the focal position Pf.

The pulse width counter 48 counts up the wobble digitized signals Sbw with the reference clock CKr from when the rising edge of the wobble digitized signal Sbw is detected until the next rising edge is detected, thereby generating a count signal Spb. The count value CB (the count signal Spb) is integrated for a specified period of time by the mean value calculator 49, and the result of the integration operation is stored in a register 53. When the detection at the pulse width counter 48 ends, the pulse width counter 48 is reset. The pulse width counter 48 is reset also by the gate signal Sg described above and a timer TMb of a specified period of time. The period of the timer TMb is set to be at least a period of time sufficient for stably obtaining the period of the wobble signal of any type of medium to be identified.

A mean pulse width count value CBmean, which is the mean value of the count signal (Spb) of the count value CB of the wobble period detected by the wobble signal detector 46, is compared with an expected value for each type of an optical disk, thereby identifying the type of the optical disk. While these operations are performed by means of software in the present invention, they may alternatively be performed by means of hardware.

While the center frequency of the BPF 55 of the wobble signal detector 46 is not particularly specified herein, the center frequency may be variable so that the type of an optical disk is identified based on the presence/absence of a detected wobble signal. This is particularly effective for very different wobble center frequencies such as those of DVD+R and DVD+RW.

While the drive value of the focus drive control data Dcf of the focus driver 33 at the focal position Pf is provided as a fixed output in the present embodiment, the optical pickup 3 may be wobbled from the focal position Pf with a specified period that is equal to or greater than the surface flatness variation period Fr. In such a case, the period with which the focal position Pf is crossed is equal to or greater than the surface flatness variation period, thereby reducing the amount of time required for the identification.

Note that it is possible that 4.7-GB DVD-RAM cannot be accurately identified from DVD-R or DVD-RW based on the wobble frequency FW since their wobble center frequencies are close to each other. Thus, in the present invention, 4.7-GB DVD-RAM and DVD-R or DVD-RW are identified from each other as follows.

The above optical disk identification operation is performed by irradiating a region of the disk 1 that is about 25 mm away from the center position of the disk 1 with laser light from the optical pickup 3. However, when the optical disk 1 is a DVD-RAM disk, a similar identification process is performed while moving the optical pickup 3 to the embossed pit region of DVD-RAM, which is within a distance of 22.6 mm to 24 mm away from the center of the optical disk 1. Note that since the rewritable region of a DVD RAM disk is located closer to the outer periphery than the position 24 mm away from the disk center position, the optical pickup 3 is preferably moved to a region about 25 mm away from thee disk center position taking into consideration the eccentricity component of the optical disk.

Since the wobble signal Swv cannot be detected from the embossed pit region for DVD-RAM disks, if the determination process is performed in the region that is 22.6 mm to 24 mm away from the center position, it is possible to identify DVD-R or DVD-RW and 4.7-GB DVD-RAM from each other, which would be difficult based only on the wobble period PW.

Thus, the means for identifying the recording density of the optical disk 1 from the frequency of the RF signal Srf and the means for taking in the wobble signal Swv and identifying the wobble period of a recordable optical disk from the frequency of the wobble signal Swv are used at the same time, and the means are used both in the rewritable region and in the embossed pit region of DVD-RAM. Therefore, it is possible, for example, to identify a CD and a DVD from each other and identify the number of recording layers of a DVD based on the recording density and the longest pattern detection frequency, to identify the type of a recordable disk based on the presence/absence and period of wobbles, and also to identify DVD-R or DVD-RW from 4.7-GB DVD-RAM, which have substantially the same wobble period, based on the presence/absence of the wobble signal in the embossed pit region.

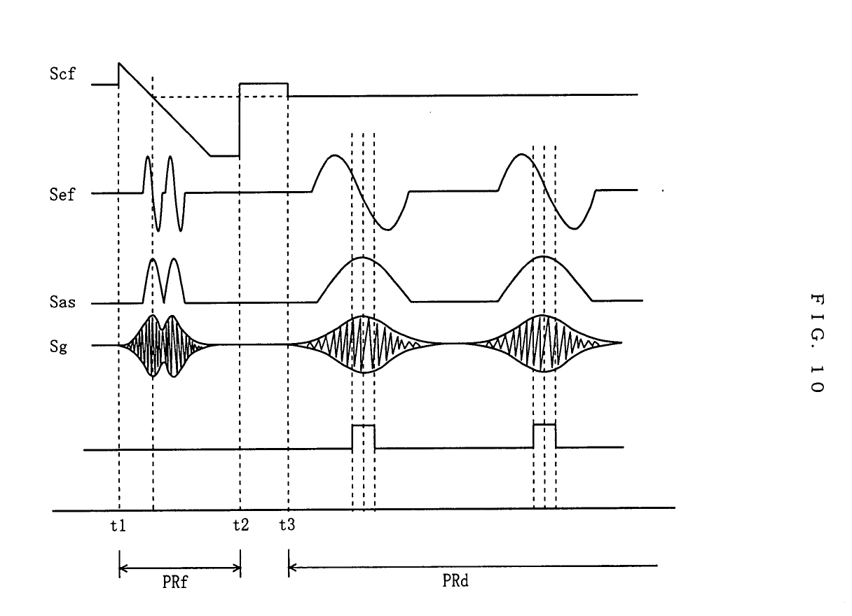

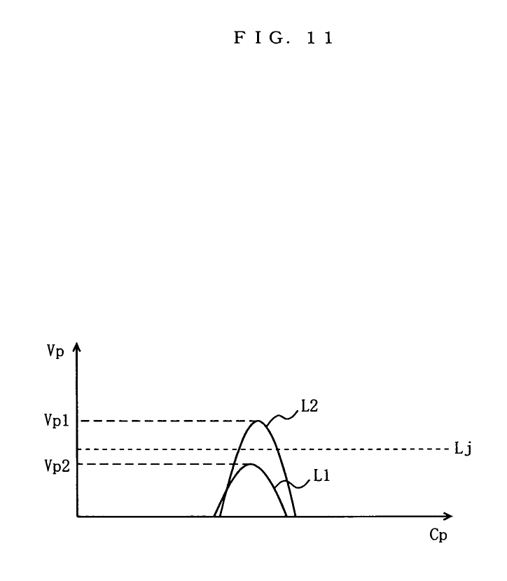

Referring now to FIG. 10 and FIG. 11, a method for identifying the number of recording layers of a DVD will be described. FIG. 10 shows the temporal relationship between the focus drive control signal Scf at the focal position Pf, the focus error signal Sef, the total sum signal Sas, and the gate signal Sg (which is generated based on the RF signal Srf, the focus error signal Sef and the total sum signal Sas) in a case where the optical disk 1 is a double-layer DVD disk. Note that the period t1-t2 is the focus adjustment period PRf, and the period after time t3 is the optical disk identification period PRd.

As described above, the longest pattern length of a double-layer DVD disk, 2.054 μm, is longer than that of a single-layer DVD disk, 1.866 μm. Therefore, with an equal amount of surface flatness variation, the frequency of occurrence of the longest pattern signal of a double-layer DVD disk is greater than that of a single-layer DVD disk. Moreover, the pulse width count value of the longest pattern signal of a double-layer DVD disk is greater than that of a single-layer DVD disk.

Since the integrated value obtained by an integration operation for a specified period of time depends on the frequency of occurrence of the longest pattern that can be detected for the specified period of time, the value obtained by integrating the pulse width count value for a specified period of time for a double-layer DVD disk is sufficiently greater than that for a single-layer DVD disk. However, using the pulse width count value, it is not possible to accurately identify a single-layer DVD disk and a double-layer DVD disk from each other based only on the integrated value, which is influenced by the amount of surface flatness variation of each optical disk. Therefore, in the present invention, the integrated value of the pulse width count value is normalized with the pulse length of the gate signal Sg at the focal position Pf generated based on the focus error signal Sef and the total sum signal Sas, whereby it is possible to suppress the influence from the surface flatness variation and to accurately identify a single-layer DVD disk and a double-layer DVD disk from each other.

FIG. 11 shows an outline of the result of counting the longest patterns for a specified period of time for a single-layer DVD disk and for a double-layer DVD disk. In FIG. 11, the horizontal axis represents a pulse width count value Cp, the vertical axis represents a normalized longest pattern detection frequency Vp (longest pattern detection frequency/gate signal width), a curve L1 represents the result for a single-layer DVD disk, and a curve L2 represents the result for a double-layer DVD disk. Note that a dotted line Lj extending from the vertical axis represents the identification level.

For a double-layer DVD disk, the length of the longest pattern signal for the same linear velocity is longer than that for a single-layer DVD disk by about 10%. Therefore, a peak value Vp2 of the normalized longest pattern detection frequency Vp for a double-layer DVD disk and a peak value Vp1 of the normalized longest pattern detection frequency Vp for a single-layer DVD disk are slightly shifted from each other with respect to the pulse width count value Cp. Since this shift is very small, it is difficult to identify a double-layer DVD disk and a single-layer DVD disk from each other based on the recording density. However, there is a distinct difference between the peak value Vp1 and the peak value Vp2. Therefore, with the identification level Lj previously defined between the peak value Vp1 and the peak value Vp2, it is possible to identify a single-layer DVD disk and a double-layer DVD disk from each other by comparing the peak value Vp1 and the peak value Vp2 with the identification level Lj.

As described above, in addition to identifying an optical disk based on the recording density of information recorded on the optical disk, the present invention identifies the type of a recordable optical disk such as a CD-R or a DVD-R based on the presence/absence of the wobble signal and the period of the wobble signal, and further identifies optical disks having the same recording density but having different numbers of recording layers from each other based on the count of occurrences of a particular pattern signal for a specified period of time. Moreover, by determining the recording density, the presence/absence of wobbles and the period of wobbles at two or more points, it is possible to identify an optical disk having two or more formats on the same optical disk.

In the present embodiment, DVD-R or DVD-RW is identified from 4.7-GB DVD-RAM based on the presence/absence of the wobble signal. However, since the reflected light intensity in an embossed pit region and that in a rewritable region are significantly different from each other in a DVD-RAM disk, the identification may be done alternatively based on the signal intensity difference such as the difference between the maximum or minimum value of the focus error signal in the rewritable region and that in the embossed pit region, or the difference between the maximum value of the total sum signal in the rewritable region and that in the embossed pit region. With this identification method based on the reflected light intensity, the comparison is made between the rewritable region and the embossed pit region of the same optical disk, whereby it is possible to suppress the influence of the variations between individual optical disks.

While the identification method of the present invention has been described in the present embodiment with respect to a case where a single-layer DVD disk and a CD are identified from each other or where a single-layer DVD disk and a double-layer DVD disk are identified from each other, the identification can be done in a similar manner for other types of optical disks as long as they have different recording densities or different recording layers.

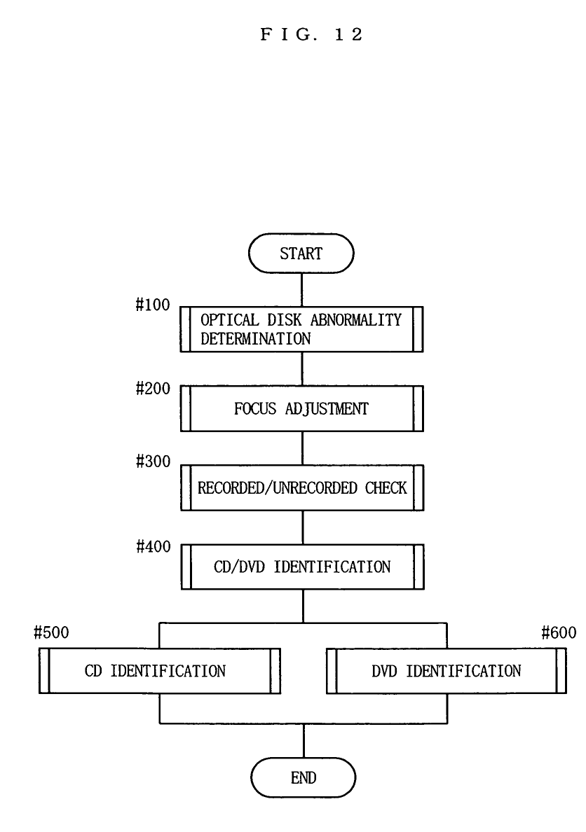

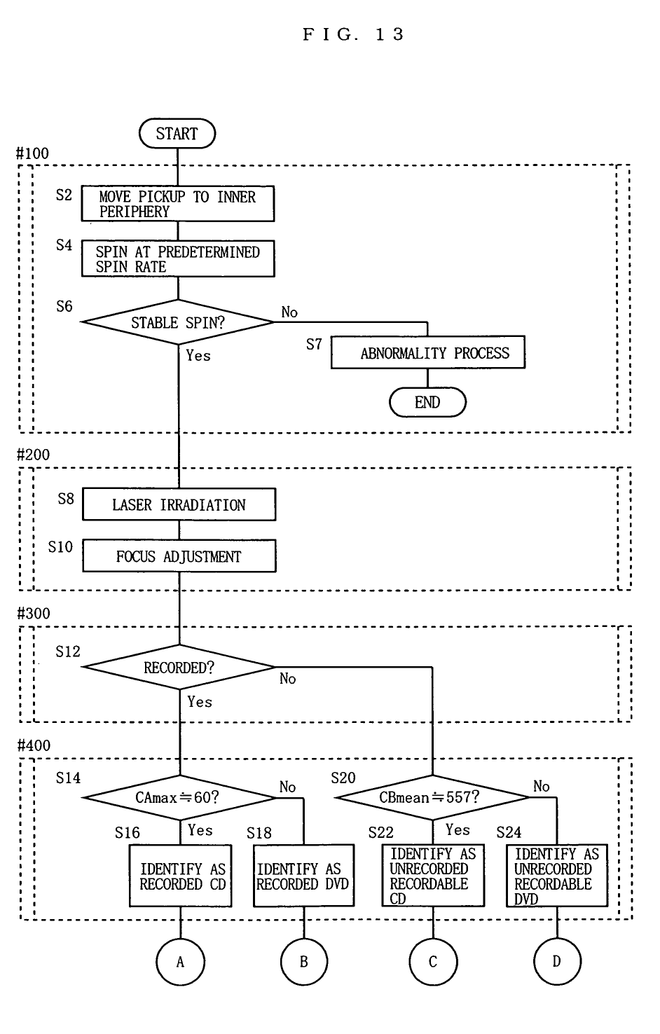

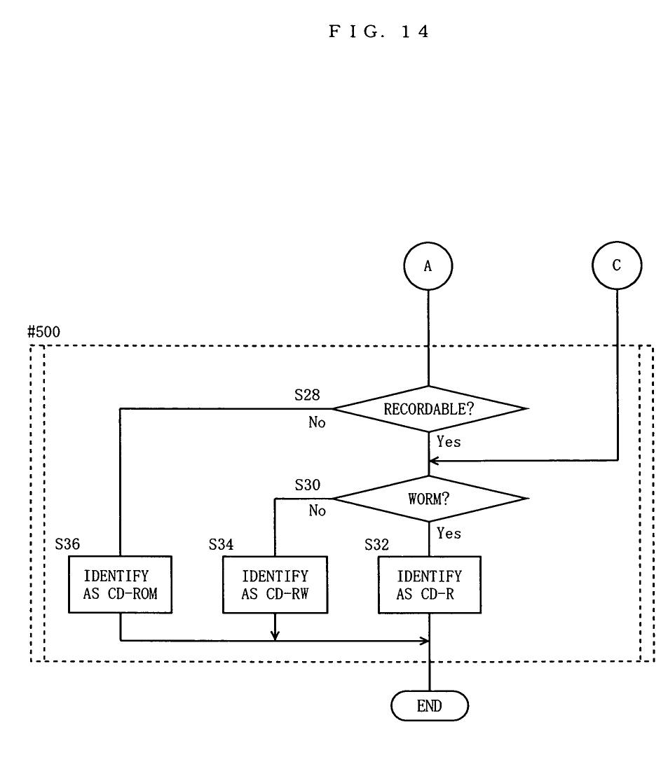

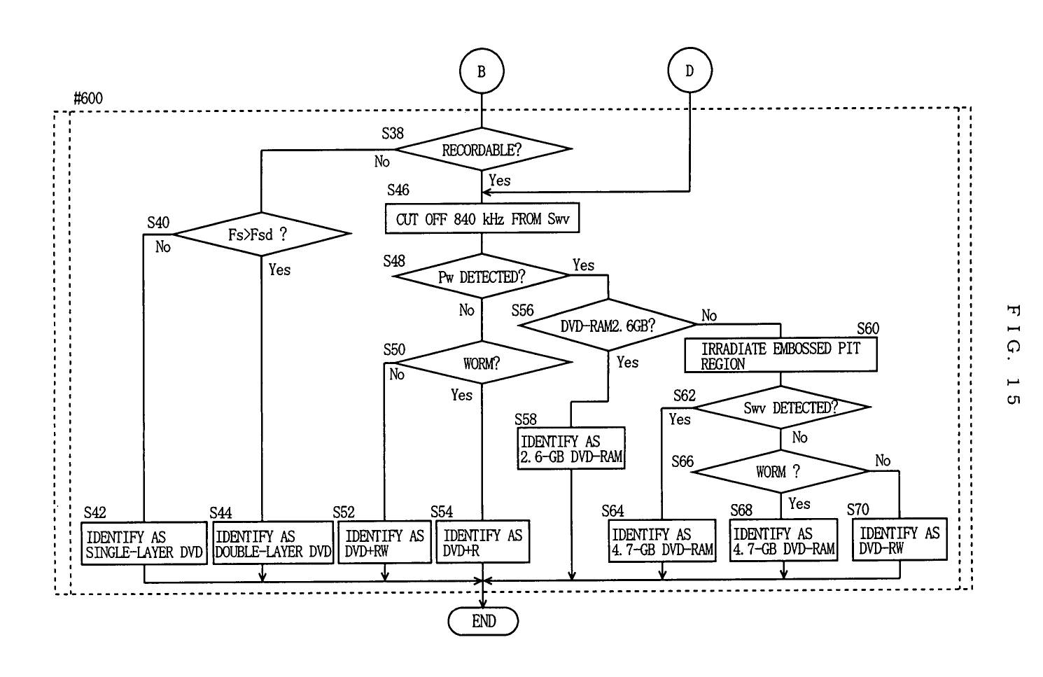

Referring now to the flow charts shown in FIG. 12, FIG. 13, FIG. 14 and FIG. 15, an optical disk identification operation according to the present embodiment will be described. With the optical disk 1 placed on the spindle 2 of the optical disk reproduction apparatus Op, the optical disk identification operation is started. FIG. 12 shows primary steps of an optical disk identification process performed by the optical disk reproduction apparatus Op, and FIG. 13 to FIG. 15 shows in detail the primary steps shown in FIG. 12.

Referring to FIG. 12, after the optical disk identification operation is started, an optical disk abnormality determination subroutine of step #100 is first performed. In the optical disk abnormality determination subroutine #100, it is determined whether or not there is an abnormality in the optical disk 1 loaded in the optical disk reproduction apparatus Op. Based on the determination result, a predetermined operation is performed. Then, the process proceeds to a focus adjustment subroutine of step #200.

In the focus adjustment subroutine #200, the focus adjustment operation as described above is performed to detect the focal position Pf of the optical pickup 3 for the optical disk 1 being actually loaded in the optical disk reproduction apparatus Op. Then, the process proceeds to a recorded/unrecorded check subroutine of step #300.

In the recorded/unrecorded check subroutine #300, it is determined whether or not data has already been recorded on the optical disk 1. Based on the determination result, a predetermined operation is performed. Then, the process proceeds to a CD/DVD identification subroutine of step #400.

In the CD/DVD identification subroutine #400, the optical disk 1 is identified to be either a CD or a DVD based on the recording density. If the optical disk 1 is identified to be a CD, the process proceeds to a CD identification subroutine of step #500. If the optical disk 1 is identified to be a DVD, the process proceeds to a DVD identification subroutine of step #600.

In the CD identification subroutine #500, it is determined which type of a CD the optical disk 1 is based on the wobble signal Swv. Then, the optical disk identification process of the present embodiment ends.

In the DVD identification subroutine #600, it is determined which type of a DVD the optical disk 1 is based on the wobble signal and the RF signal Srf. Then, the optical disk identification process of the present embodiment ends.

Referring now to FIG. 13, the operation of each of the subroutines of steps #100 to #400 will be described in detail. As shown in FIG. 13, as the optical disk abnormality determination subroutine #100 is started, the process proceeds to step S2 to move the optical pickup 3 so that an inner periphery portion of the optical disk 1 is irradiated with laser light. Then, the process proceeds to step S4.

In step S4, the spindle controller 12 generates the spindle control signal Scs and the spindle motor driver 11 generates the spindle drive signal Sds to spin the spindle 2. Then, based on the spin rate signal Ssr output from the spindle 2, the spindle controller 12 again generates the spindle control signal Scs so that the optical disk 1 stably spins at an intended rate. The process proceeds to step S6 after the passage of a predetermined time required for the spin rate of the spindle 2 to become stable by such a feedback control of the spin rate of the spindle 2.

In step S6, it is determined based on the spin rate signal Ssr whether or not the optical disk 1 (the spindle 2) is stably spinning at an intended rate. If the determination result is “No”, the process proceeds to step S7 to perform an abnormality process, such as notifying the user that the type of the optical disk cannot be identified, and the optical disk identification operation ends. If the determination result is “Yes”, the process proceeds to step S8 in the focus adjustment subroutine #200.

In step S8, an inner periphery portion of the recording surface of the optical disk 1 is irradiated with laser light from the optical pickup 3. Based on the reflected light from the inner periphery portion of the optical disk 1, the photodetector 4 generates the photodetection signals Sa, Sb, Sc and Sd, and outputs these signals to each of the focus error signal generator 13, the total sum signal generator 14, the phase difference detector 15 and the wobble signal detector 46.

Thereafter, based on the input photodetection signals Sa, Sb, Sc and Sd, the focus error signal generator 13, the total sum signal generator 14, the phase difference detector 15 and the wobble signal detector 46 successively generate the focus error signal Sef, the total sum signal Sas, the phase difference tracking error signal Set and the wobble signal Swv, respectively. The waveform equalizer 16 successively generates the RF signal Srf based on the total sum signal Sas. Similarly, the off-track signal generator 17 successively generates the phase difference off-track signal Sot based on the phase difference tracking error signal Set. Then, the process proceeds to step S10.

In step S10, the focus adjustment operation as described above is performed based on the focus error signal Sef. Then, after confirming that the optical pickup 3 is located at the focal position Pf, the process proceeds to step S12 in the recorded/unrecorded check subroutine #300.

In step S12, it is determined whether or not data has been recorded on the optical disk 1. Specifically, the optical disk 1 is determined to be “recorded” if the RF signal Srf can be detected at the focal position Pf, and to be “unrecorded” if the RF signal Srf cannot be detected. This determines that the optical disk 1 belongs to either the non-recordable disk/recorded recordable disk group or an unrecorded recordable disk group. If the optical disk 1 is a recorded disk, it is regarded as being a non-recordable disk or a recorded recordable disk, and the process proceeds to step S14 in the CD/DVD identification subroutine #400. If the optical disk 1 is not a recorded disk, it is regarded as being an unrecorded recordable disk, and the process proceeds to step S20 in the CD/DVD identification subroutine #400.

In step S14, it is determined whether or not the optical disk 1, which has been determined in step S12 to be a non-recordable disk or a recorded recordable disk, is a CD based on the maximum pulse width count value CAmax. Specifically, where the frequency of the reference clock CKr used in the pulse width counter 39 is 33 MHz, it is determined whether or not the maximum pulse width count value CAmax of the sync signal detector 31 is close to 60.

The determination of the closeness of the maximum pulse width count value CAmax in this step will be briefly described. As described above, the maximum pulse width count value CAmax of the sync signal detector 31 is supposed to be about 35 if the optical disk 1 is a DVD and about 60 if the optical disk 1 is a CD. In view of this, unlikely values for the count value CA, e.g., overflowing count values CA (CA>CAmax), are excluded, and the remaining count values CA are integrated for a specified period of time so as to identify the optical disk 1 to be either a CD or a DVD based on whether or not the mean value is close to the expected value for a DVD (35) or that for a CD (60). If the determination result is “Yes”, the process proceeds to step S16.

In step S16, the optical disk 1 is identified to be a recorded CD. A “recorded CD” as used herein refers to a CD-R or a CD-RW on which information has already been recorded, or a CD-ROM. The determination result is saved in the optical disk reproduction apparatus Op, the optical disk identification device or any other appropriate storage medium as instruction information, which is used in subsequent operations such as the reproduction of the optical disk 1. As necessary, the determination result may be presented to the user visually or by a sound. Then, the process proceeds to step S28 in the CD identification subroutine #500.

If it is determined in step S14 that the maximum pulse width count value CAmax is not close to 60, the process proceeds to step S18, where the optical disk 1 is identified to be a recorded DVD. A “recorded DVD” as used herein refers to a DVD-R, a DVD-RW, a DVD+R, a DVD+RW or a DVD-RAM, on which information has already been recorded, or a DVD-ROM. As in step S16, the determination result is stored as instruction information and is presented to the user as necessary. In the present invention, the result of the identification of the optical disk 1 is processed as in steps S16 and S18 in a step of identifying the optical disk 1, unless otherwise specified. Then, the process proceeds to step S38 in the DVD identification subroutine #600.

In step S20, it is determined whether or not the disk 1, which has been determined in step S12 to be an unrecorded recordable disk, is a CD. Specifically, it is determined whether or not the mean pulse width count value CBmean is close to 557, which is the expected value for a CD-R or a CD-RW. If the determination result is “Yes”, the process proceeds to step S22. If the determination result is “No”, the process proceeds to step S24.

In step S22, the optical disk 1 is identified to be an unrecorded recordable CD. An “unrecorded recordable CD” as used herein refers to a CD-R or a CD-RW, on which no data has been recorded. Then, the process proceeds to step S30 in the CD identification subroutine #500.

In step S24, the optical disk 1 is identified to be an unrecorded recordable DVD. An “unrecorded recordable DVD” as used herein refers to a DVD-R, a DVD-RW, a DVD+R, a DVD+RW or a DVD-RAM, on which no data has been recorded. Then, the process proceeds to step S46 in the DVD identification subroutine #600.

In step S14, 35 (the expected count value for a DVD) may be used instead of 60 (the expected count value for a CD). In step S20, 234 (the expected count value for a DVD-), 39 (the expected count value for a DVD+), 359 (the expected count value for a 2.6-GB DVD-RAM) or about 246 (the expected count value for a 4.7-GB DVD-RAM) may be used instead of 557 (the expected count value for a CD). Alternatively, steps may be added such that comparisons with these count values are performed hierarchically.

Referring now to FIG. 14, the operation of the CD identification subroutine #500 will be described. After the optical disk 1 is identified to be a recorded CD in the CD/DVD identification subroutine #400 (step S16), the process first proceeds to step S28 to determine whether or not the optical disk 1, which has been determined to be a recorded CD in step S12 (#300) and step S14 (#400), is a recordable disk. Specifically, it is determined whether or not the wobble signal period PW is detected from the wobble signal Swv by the wobble signal detector 46. If it is not detected, i.e., if the determination result is “No”, the optical disk 1 is determined to be a non-recordable CD, and the process proceeds to step S36.

In step S36, the optical disk 1 is identified to be a non-recordable CD, i.e., a CD-ROM. Then, the optical disk identification process ends.

If the wobble period PW is detected, i.e., the detection result is “Yes”, in step S28, the optical disk 1 is determined to be a recordable CD. Then, the process proceeds to step S30.

In step S30, it is determined whether or not the optical disk 1, which has been identified to be an unrecorded CD in the CD/DVD identification subroutine #400 (step S22), or the optical disk 1, which has been identified to be a recordable recorded CD in step S28, is a WORM (Write-Once Read-Many) disk. Specifically, if the determination result is “Yes”, the optical disk 1 is determined to be a WORM disk, and the process proceeds to step S32. If the determination result is “No”, the optical disk 1 is determined to be not a WORM disk, and the process proceeds to step S34.

In step S32, the optical disk 1 is identified to be a WORM recordable CD, i.e., a CD-R. Then, the optical disk identification process ends.

In step S34, the optical disk 1 is identified to be a non-WORM recordable CD, i.e., a CD-RW. Then, the optical disk identification process of the present embodiment ends.

Referring now to FIG. 15, the operation of the DVD identification subroutine #600 will be described. First, in step S38, it is determined whether or not the optical disk 1, which has been identified to be a recorded DVD in the CD/DVD identification subroutine #400 (S18), is a recordable disk. Specifically, it is determined whether or not the wobble period PW is detected from the wobble signal Swv by the wobble signal detector 46. If the determination result is “No”, the optical disk 1 is determined to be a non-recordable DVD, i.e., a DVD-ROM, and the process proceeds to step S40.

In step S40, it is determined whether or not the optical disk 1, which has been determined to be a DVD-ROM in step S38, is a double-layer disk. Specifically, it is determined whether or not the frequency of detection of the sync signal (the peak value Vp) is greater than a predetermined value (the identification level Lj), as described above with reference to FIG. 11. The process proceeds to step S42 if the determination result is “No”, and to step S44 if the determination result is “Yes”.

In step S42, the optical disk 1 is identified to be a single-layer DVD-ROM. Then, the optical disk identification process ends.

In step S44, the optical disk 1 is identified to be a double-layer DVD-ROM. Then, the optical disk identification process ends.

If the determination result of step S38 is “Yes”, i.e., if the optical disk 1 is determined to be a recorded recordable DVD, the process proceeds to step S46. The process proceeds to step S46 also if the optical disk 1 is determined to be an unrecorded recordable DVD in the CD/DVD identification subroutine #400 (S24).

In step S46, for further identification of the optical disk 1, which has been determined to be a recordable DVD, the wobble signal Swv is passed through the bandpass filter 55 to remove a 840-kHz frequency component, which is inherent to the wobble signal Swv for DVD+R and DVD+RW. Then, the process proceeds to step S48.

In step S48, it is determined whether or not the wobble period PW is detected from the wobble signal Swv, from which the 840-kHz frequency component has been removed. If the determination result is “No”, indicating that the wobble period PW detected in step S38 is 1/840000, the process proceeds to step S50, where it is determined whether the optical disk 1 is a DVD+R or a DVD+RW.

In step S50, it is determined whether or not the optical disk 1 is a WORM disk. Specifically, as in step S30 described above, if a value As of the total sum signal Sas at the focal position Pf is less than or equal to a predetermined value AsDW, the optical disk 1 is determined to be not a WORM disk, and the process proceeds to step S52. If the value of the total sum signal Sas is greater than the predetermined value AsDW, the optical disk 1 is determined to be a WORM disk, and the process proceeds to step S54.

In step S52, the optical disk 1 is identified to be a DVD+RW. Then, the optical disk identification process ends.

In step S54, the optical disk 1 is identified to be a DVD+R. Then, the optical disk identification process ends.

If the determination result of step S48 is “Yes”, indicating that the wobble period PW of the wobble signal Swv is other than 1/840000 (the wobble frequency FW is other than 840 kHz), the process proceeds to step S56.

In step S56, it is determined whether or not the optical disk 1 is a 2.6-GB DVD-RAM. Specifically, if the detected wobble period PW of the switching signal SW is close to 1/92000, the determination result is “Yes”, and the process proceeds to step S58. If the wobble period PW is not close to 1/92000, the determination result is “No”, and the process proceeds to step S60.

In step S58, the optical disk 1 is identified to be a 2.6-GB DVD-RAM. Then, the optical disk identification process ends.

In step S60, the optical pickup 3 is moved so that the embossed pit region in the lead-in area of the optical disk 1 is irradiated with laser light. Immediately after the optical pickup 3 is moved, a focus adjustment operation at this position is performed, as in step S10 described above. Then, the process proceeds to step S62.

In step S62, it is determined whether or not the wobble signal Swv can be detected. If the determination result is “Yes”, the optical disk 1 is determined to be a DVD-RAM other than a 2.6-GB DVD-RAM, and the process proceeds to step S64.

In step S64, the optical disk 1 is identified to be a 4.7-GB DVD-RAM. This is based on the fact that the DVD-RAMs currently being in practical use are either those of a 2.6-GB capacity or those of a 4.7-GB capacity. Even when DVD-RAMs other than the 2.6-GB and 4.7-GB DVD-RAMs are put into practical use, a DVD-RAM of a certain capacity can be identified from others based on whether or not the wobble frequency corresponding to that capacity is detected, as in step S56.

In step S64, it is determined whether or not the recordable DVD, which has been determined in step S62 to be not a DVD-RAM, is a WORM disk. Specifically, as in step S50 described above, if the value As of the total sum signal Sas at the focal position Pf is greater than a predetermined value AsDR, the optical disk 1 is determined to be a WORM disk, and the process proceeds to step S68. If the value of the total sum signal Sas is less than or equal to the predetermined value AsDR, the optical disk 1 is determined to be not a WORM disk, and the process proceeds to step S70.

In step S68, the optical disk 1 is identified to be a DVD-R. Then, the optical disk identification process ends.

In step S70, the optical disk 1 is identified to be a DVD-RW. Then, the optical disk identification process ends.

In the subroutine #400, the identification method is described with respect to a case where a single-layer DVD disk and a CD are identified from each other. However, it is clear that other types of optical disks can be identified from one another in a similar manner as long as they have different recording densities.

An identification method for an optical disk having a plurality of formats on the same disk is shown above for DVD-RAM, DVD-R and DVD-RW.

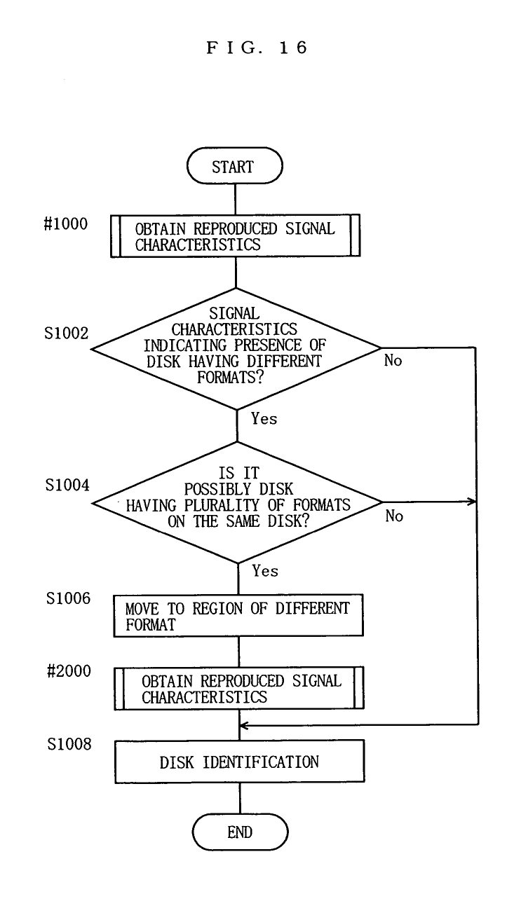

Referring to FIG. 16, a typical method for identifying an optical disk having a plurality of formats will be described.

First, in a reproduced signal obtaining subroutine of step #1000, reproduction information needed for the identification is obtained from a predetermined position (an inner periphery portion) of the optical disk 1 as described above.

Then, in step S1002, it is determined whether or not the characteristics of the signal reproduced from the optical disk 1 indicate the presence of a disk having different formats. If the determination result is “No”, the process proceeds to step S1008. If the determination result is “Yes”, the process proceeds to step S1004.

In step S1004, it is determined whether or not the characteristics of the reproduced signal are those of a disk having two ormore different formats. If the determination result is “No”, the process proceeds to step S1008. If the determination result is “Yes”, the process proceeds to step S1006.

In step S1006, the optical pickup 3 is moved to a region of a different format on the optical disk 1. Then, the process proceeds to a reproduced signal obtaining subroutine of step #2000.

In step #2000, reproduction information needed for the identification is obtained from the region of the different format, as in step #1000. Then, the process proceeds to step S1008.

In step S1008, if the determination result of step S1002 is “No”, the type of the optical disk 1 is identified based on the reproduction information obtained in step #1000. If the determination result of step S1004 is “No”, the type of the optical disk 1 is identified based on the reproduction information obtained in step #1000 and the amount-of-light characteristics. If the determination result is “Yes” both in steps S1002 and S1004, the optical disk 1 is identified to be a disk having two formats based on the two types of reproduction information obtained in steps #1000 and #2000.

While the focus drive control data Dcf of the focus driver 33 at the focal position Pf is fixed in the above description, the optical pickup 3 may alternatively be wobbled from the focal position Pf with a specified period that is equal to or greater than the surface flatness variation period Fr. In such a case, the period with which the focal position Pf is crossed is equal to or greater than the surface flatness variation period Fr, thereby reducing the amount of time required for the identification.

In the above description, the logical product of the first gate signal Sg1 generated based on the focus error signal Sef and the second gate signal Sg2 generated based on the total sum signal Sas is used as the gate signal Sg. This is to more accurately generate the gate signal, which is the means for detecting the focal position Pf. Alternatively, one of the first gate signal Sg1 and the second gate signal Sg2, or the logical sum of these signals may be used as the gate signal Sg.

As the gate signal for taking in the RF signal Srf, a tracking error signal generated by the three-beam method, which is conventionally used for CDs, may be used instead of the phase difference off-track signal Sot generated from a tracking error signal that is generated by the differential phase detection method. Alternatively, the gate signal based on the off-track information may not be used. The selection can be made based on how much the comparison with the expected count value is influenced by the gate signal. Moreover, laser light other than those for DVDs having a wavelength of 650 nm may be used as long as it is possible to obtain the information recorded on an optical disk.

In the present embodiment, the means for determining the recording density of an optical disk from the frequency of the RF signal Srf and the means for taking in the wobble signals Swv to identify the wobble period of the recordable optical disk from the frequency of the wobble signal Swv are used at the same time, whereby it is possible to identify CDs and DVDs from each other based on the recording density and to identify different types of recordable disks from one another based on the presence/absence of wobbles and the wobble period. Moreover, it is possible to identify an optical disk based on whether or not there are a plurality of formats on the same optical disk.

The present embodiment is directed to the identification of different types of optical disks currently being in practical use, including CD-ROM, CD-R, CD-RW, DVD-ROM (single-layer/double-layer), DVD-RAM (2.6 GB/4.7 GB), DVD-R, DVD-RW, DVD+R and DVD+RW. It is clear that the present invention can be used for identifying other types of optical disks to be put into practical use in the future as long as they have different characteristics with respect to the recording density, the wobble signal, etc.

As described above, in the present invention, the sync information of the recorded data and the wobble information are used as means for identifying the type of the optical disk 1. These sources of information, i.e., the sync signal and the wobble signal, each appear a certain number of times for each section of the gate signal Sg. While the length of the gate signal Sg varies depending on the characteristics (kinds) of the optical disk 1, the number of sync information and wobble information appearing for each high-level section (length) of the gate signal Sg is fixed. Therefore, without the filtering operation, it is possible to obtain the same information as the signal obtained through the focusing operation by taking in data (continuously scanning the optical disk 1) for an amount of time such that the period for which the signal is taken in while performing the filtering operation is equal to the sum of the length of the gate signal Sg.

Moreover, it is possible to increase the frequency of occurrence of the RF signal or the wobble signal detected for a specified period of time by wobbling the focus actuator 34 to move the optical pickup 3 up and down from the focal position Pf with a specified period in order to detect the RF signal or extract the wobble signal Swv from the photodetection signals Sa, Sb, Sc and Sd.

While the invention has been described in detail, the foregoing description is in all aspects illustrative and not restrictive. It is understood that numerous other modifications and variations can be devised without departing from the scope of the invention.

1. An optical disk identification device for identifying at least two types of optical disks of different formats from each other, comprising:
means for spinning an optical disk;
optical pickup means for irradiating a recording surface of the optical disk with laser light and receiving reflected light from the recording surface;
focus drive control means for generating a focus drive value for driving focus actuator means for adjusting a distance between an object lens of the pickup means and the recording surface;
photodetection signal generation means for generating a photodetection signal representing a state of the recording surface based on an intensity of the reflected light;
focus drive value detection means for detecting, based on the photodetection signal, a focus drive value when the object lens is located at a focal position at which the laser light properly converges to form a spot on the recording surface;
focal position fixing means for providing a fixed output of the detected focus drive value to the focus actuator means to fix the object lens at the detected focal position;
focal position detection means for generating, based on the photodetection signal, a focal position detection signal that is either at a high level or at a low level when the object lens is located at the focal position;
RF signal detection means for detecting an RF signal from the photodetection signal based on the focal position detection signal;
recording density identification means for identifying a recording density of the optical disk based on the RF signal; and
format identification means for identifying a format of the optical disk based on the detected recording density.

2. An optical disk identification device for identifying at least two types of optical disks of different formats from each other, comprising:
means for spinning an optical disk;
pickup means for irradiating a recording surface of the optical disk with laser light and receiving reflected light from the recording surface;
focus drive control means for generating a focus drive value for driving focus actuator means for adjusting a distance between an object lens of the pickup means and the recording surface;
photodetection signal generation means for generating a photodetection signal representing a state of the recording surface based on an intensity of the reflected light;
focus drive value detection means for detecting, based on the photodetection signal, a focus drive value when the object lens is located at a focal position at which the laser light properly converges to form a spot on the recording surface;
focal position fixing means for providing a fixed output of the detected focus drive value to the focus actuator means to fix the object lens at the detected focal position;
focal position detection means for generating, based on the photodetection signal, a focal position detection signal that is either at a high level or at a low level when the object lens is located at the focal position;
wobble signal extraction means for extracting, from the photodetection signal, a wobble signal provided along a guide groove on the recording surface based on the focal position detection signal;
wobble period identification means for detecting a wobble period of the guide groove recorded on the recording surface based on the wobble signal; and
format identification means for identifying a format of the optical disk based on the detected wobble period.

3. An optical disk identification device for identifying at least two types of optical disks of different formats from each other, comprising:
means for spinning an optical disk;
optical pickup means for irradiating a recording surface of the optical disk with laser light and receiving reflected light from the recording surface;
focus drive control means for generating a focus drive value for driving focus actuator means for adjusting a distance between an object lens of the pickup means and the recording surface;
photodetection signal generation means for generating a photodetection signal representing a state of the recording surface based on an intensity of the reflected light;
focus drive value detection means for detecting, based on the photodetection signal, a focus drive value when the object lens is located at a focal position at which the laser light properly converges to form a spot on the recording surface;
focal position fixing means for providing a fixed output of the detected focus drive value to the focus actuator means to fix the object lens at the detected focal position;
focal position detection means for generating, based on the photodetection signal, a focal position detection signal that is either at a high level or at a low level when the object lens is located at the focal position;
RF signal detection means for detecting an RF signal from the photodetection signal based on the focal position detection signal;
recording density identification means for identifying a recording density of the optical disk based on the RF signal;
wobble period identification means for detecting a wobble period of the guide groove recorded on the recording surface based on the wobble signal; and
format identification means for identifying a format of the optical disk based on the detected recording density and the detected wobble period.

4. The optical disk identification device according to claim 1, wherein the recording density identification means comprises:
counter means for counting the number of the RF signals detected for a specified period of time to output a pulse width count value;
count value normalization means for normalizing the pulse width count value with a focal position detection period based on the photodetection signal to calculate a normalized count value; and
number of recording layers identification means for identifying the number of recording layers of the optical disk based on the calculated normalized count value.

5. The optical disk identification device according to claim 1, further comprising focus wobbling means for wobbling the focus actuator means to vary a distance between the object lens and the recording surface about the focal position with a specified period, so as to increase a frequency of occurrence of the RF signal detected for a specified period of time.

6. The optical disk identification device according to claim 2, further comprising focus wobbling means for wobbling the focus actuator means to vary a distance between the object lens and the recording surface about the focal position with a specified period, so as to increase a frequency of occurrence of the wobble signal detected for a specified period of time.

7. The optical disk identification device according to claim 2 for identifying an optical disk having at least two types of formats on the optical disk, comprising:
first optical pickup moving means for moving the optical pickup to a first predetermined position with respect to a radial direction of the recording surface;
first signal information storing means for storing, as first reproduction information, at least one of the focal position detection signal, the wobble signal and the wobble period, which are generated based on reflected light from the recording surface irradiated with laser light from the first predetermined position;
second optical pickup moving means for moving the optical pickup to a second predetermined position, different from the first predetermined position, with respect to the radial direction of the recording surface;
second signal information storing means for storing, as second reproduction information, at least one of the focal position detection signal, the wobble signal and the wobble period, which are generated based on reflected light from the recording surface irradiated with laser light from the second predetermined position;
reproduction information comparison means for comparing the first reproduction information and the second reproduction information with each other; and
multi-format identification means for identifying an optical disk having at least two types of formats based on a comparison result from the reproduction information comparison means.

8. The optical disk identification device according to claim 1, wherein the focal position detection means comprises focus error detection means for generating a focus error signal for detecting a position of the object lens based on the photodetection signal, wherein the object lens being at the focal position is detected based on a maximum value and a minimum value of the focus error signal.

9. The optical disk identification device according to claim 1, wherein the focal position detection means comprises total sum signal generation means for generating a total sum signal based on the photodetection signal, wherein the object lens being at the focal position is detected based on a maximum value of the total sum signal.

10. The optical disk identification device according to claim 1, wherein the focal position detection means comprises:
first focal position detection means including focus error detection means for generating a focus error signal for detecting a position of the object lens based on the photodetection signal, wherein the first focal position detection means detects the object lens being at the focal position based on a maximum value and a minimum value of the focus error signal; and
second focal position detection means including total sum signal generation means for generating a total sum signal based on the photodetection signal, wherein the second focal position detection means detects the object lens being at the focal position based on a maximum value of the total sum signal,
wherein the focal position detection means detects the object lens being at the focal position when at least one of the first focal position detection means and the second focal position detection means detects the object lens being at the focal position.

11. The optical disk identification device according to claim 7, wherein the first reproduction information and the second reproduction information are both a wobble period.

12. The optical disk identification device according to claim 1, further comprising focus error detection means for generating a focus error signal for detecting a position of the object lens based on the photodetection signal,
wherein the focus drive value detection means detects the focus drive value at a zero-crossing point of a waveform of the focus error signal.

13. The optical disk identification device according to claim 2, the wobble signal extraction means comprising wobble frequency filtering means for filtering the wobble signal with a bandpass filter whose center frequency is variable,
wherein the format identification means identifies a format of the optical disk based on a wobble frequency filtered through the filtering means.

14. A signal processing device for use in an optical disk identification device for irradiating a recording surface of an optical disk with laser light while fixing an object lens at a focal position by a focus actuator so that the laser light properly forms a spot on the recording surface so as to identify at least two types of optical disks of different formats from each other based on a photodetection signal according to the laser light reflected from the recording surface, the signal processing device comprising:
focus drive value detection means for detecting a focus drive value for driving the focus actuator when the object lens is located at the focal position based on the photodetection signal;
focal position fixing means for providing a fixed output of the detected focus drive value to the focus actuator to fix the object lens at the detected focal position;
focal position detection means for generating, based on the photodetection signal, a focal position detection signal that is either at a high level or at a low level when the object lens is located at the focal position;
RF signal detection means for detecting an RF signal from the photodetection signal based on the focal position detection signal;
recording density identification means for identifying a recording density of the optical disk based on the RF signal; and
format identification means for identifying a format of the optical disk based on the detected recording density.

15. A signal processing device for use in an optical disk identification device for irradiating a recording surface of an optical disk with laser light while fixing an object lens at a focal position by a focus actuator so that the laser light properly forms a spot on the recording surface so as to identify at least two types of optical disks of different formats from each other based on a photodetection signal according to the laser light reflected from the recording surface, the signal processing device comprising:
focus drive value detection means for detecting a focus drive value for driving the focus actuator when the object lens is located at the focal position based on the photodetection signal;
focal position fixing means for providing a fixed output of the detected focus drive value to the focus actuator to fix the object lens at the detected focal position;
focal position detection means for generating, based on the photodetection signal, a focal position detection signal that is either at a high level or at a low level when the object lens is located at the focal position;
wobble signal extraction means for extracting, from the photodetection signal, a wobble signal provided along a guide groove on the recording surface based on the focal position detection signal;
wobble period identification means for detecting a wobble period of the guide groove recorded on the recording surface based on the wobble signal; and
format identification means for identifying a format of the optical disk based on the detected wobble period.

16. A signal processing device for use in an optical disk identification device for irradiating a recording surface of an optical disk with laser light while fixing an object lens at a focal position by a focus actuator so that the laser light properly forms a spot on the recording surface so as to identify at least two types of optical disks of different formats from each other based on a photodetection signal according to the laser light reflected from the recording surface, the signal processing device comprising:
focus drive value detection means for detecting a focus drive value for driving the focus actuator when the object lens is located at the focal position based on the photodetection signal;
focal position fixing means for providing a fixed output of the detected focus drive value to the focus actuator to fix the object lens at the detected focal position;
focal position detection means for generating, based on the photodetection signal, a focal position detection signal that is either at a high level or at a low level when the object lens is located at the focal position;
RF signal detection means for detecting an RF signal from the photodetection signal based on the focal position detection signal;
recording density identification means for identifying a recording density of the optical disk based on the RF signal;
wobble period identification means for detecting a wobble period of the guide groove recorded on the recording surface based on the wobble signal; and
format identification means for identifying a format of the optical disk based on the detected recording density and the detected wobble period.
